(19) United States
(12) Patent Application Publication
(10) Pub. No.: US 2016/0350834 A1
(43) Pub. Date: Dec. 1, 2016

(54) SYSTEMS AND METHODS FOR CONSTRUCTING AND APPLYING SYNAPTIC NETWORKS

(71) Applicant: NARA LOGICS, INC., Cambridge, MA (US)

(72) Inventors: Nathan R. WILSON, Watertown, MA (US); Sahil ZUBAIR, Boston, MA (US); Denise ICHINCO, Somerville, MA (US); Raymond J. PLANTE, Boston, MA (US); Jana B. EGGERS, Boston, MA (US)

(73) Assignee: NARA LOGICS, INC., Cambridge, MA (US)

(21) Appl. No.: 15/170,574

(22) Filed: Jun. 1, 2016

Related U.S. Application Data
(60) Provisional application No. 62/169,399, filed on Jun. 1, 2015.

(51) Int. Cl. G06Q 30/06; G06N 3/04; G06F 17/30

(52) U.S. Cl. CPC G06Q 30/0631; G06F 17/30867; G06N 3/0427

(57) ABSTRACT

A recommendation generator builds a synaptic network of nodes corresponding to items, attributes, and reviews. The synaptic network includes connections between nodes where each connection reflects a strength of an interrelationship between two or more of the nodes. The connection strengths are a function of one or more synaptic learning rules, and recommendation generator determines recommended items to a user based on the connection strengths. Accordingly, the advancements described herein provide for the creation of improved data networks that improves the way data is stored and retrieved, thereby providing faster and more accurate processing of data which enables faster and more accurate searching when presenting recommendations than is possible with traditional network infrastructures. Therefore, the advancements described herein improve existing technological processes in a variety of technical arenas such as data storage, network architecture, forming data relationships and recommendation processing.

### CROSS-REFERENCE TO RELATED PATENT APPLICATIONS

The present application claims the benefit of the earlier filing date of U.S. provisional applications 62/169,399 having with the present application and filed in the U.S. Patent and Trademark Office on Jun. 1, 2015, the entire contents of which being incorporated herein by reference.

### BACKGROUND

Search engines may output lists of hyperlinks for web pages that include information of interest. Some search engines base the determination of corresponding hyperlinks on a search query entered by the user. The goal of the search engine is to return links for high quality, relevant sites based on the search query. Most commonly, search engines accomplish this by matching the terms in the search query to a database of stored web pages or web page content. Web pages that include the terms in the search query are considered “hits” and are included in the list of hyperlinks presented to the user.

To increase efficacy of the search, a search engine may rank the list of hits or hyperlinks according to the relevance or quality. For example, the search engine may assign a grade or rank to each hit, and the score may be assigned to correspond to the relevance or importance of the web page. Conventional methods of determining importance or relevance are based on the content of each web page including the link structure of the web page.

Many conventional search engines utilize an indexing system for identifying web pages available on the Internet. The indexing system identifies words in the pages and creates an index of those words. The system responds to user queries by analyzing the index and identifying the pages that are most relevant to the users query.

The relevance ranking or determination can be executed in various ways. The citation of one site or page by other sites or pages is sometimes used as one measure of relevance. Web page metadata is also sometimes used in a determination of relevance.

Neural networks have also been used in the field of Internet searching. It is assumed, for purposes of this description, that the reader is familiar with how neural networks operate. A neural network can consist of three basic aspects—a neuron or node, definitions of how the neurons or nodes are interconnected or related to each other, and the manner in which that topology is updated over time.

### SUMMARY

In selected embodiments a recommendation generator builds a synaptic network of nodes corresponding to items, attributes, and reviews. The synaptic network also includes connections between the nodes where each connection reflects strengths of interrelationships between two or more of the nodes. The connection strengths are a function of one or more synaptic learning rules, and recommendation generator determines recommended items to a user based on the connection strengths. The system architecture in various embodiments may permit efficient, localized updating of the synaptic network in response to alteration of the connection strengths between various nodes.

Aspects of the present disclosure are directed to generating recommendations for users based on learned relationships between nodes of a synaptic network where the nodes represent users, items, and attributes that describe the users and items. Advancement in processing and computing technologies provides the ability to construct and manipulate complex data networks according to the implementations described herein. The synaptic learning rules described herein can be codified into an engineering framework that can be applied to computing systems in order to provide more accurate representations of relationships between items, attributes, and users. The implementations described herein improve the functionality of computerized neural networks and can be applied across a wide range of technologies that use neural networks to determine patterns and trends in data. For example, aspects of the implementations described herein can also be applied to fraud detection, pattern recognition algorithms, physical system modeling, biometric signal processing, student performance predictors, energy demand predictors, etc. In addition, the distributed representation model and hybrid model described herein improve the functionality of traditional neural networks by combining features of distributed representation neural networks and synaptic networks.

Accordingly, the advancements described herein provide for the creation of improved data networks that enhance the way data is stored and retrieved, thereby providing faster processing of data and enabling faster and more accurate searching when presenting recommendations than is possible with traditional network infrastructures. Therefore, the advancements described herein improve existing technological processes in a variety of technical arenas such as data storage, network architecture, forming data relationships and recommendation processing. Thus, the systems and methods described herein are directed to a novel implementation implemented via special purpose computing rather than mere generic features implemented on a general-purpose computer.

The details of one or more implementations are set forth in the accompanying drawing and description below. Other features, objects, and advantages will be apparent from the description and drawings, and from the claims.

### BRIEF DESCRIPTION OF FIGURES

FIG. 1 is an exemplary diagram of a traditional neural network and a synaptic network, according to one example;

FIG. 2 is a block diagram of an environment for developing and utilizing a network of interrelated nodes, according to one example;

FIG. 3 is an exemplary table showing types of nodes in a synaptic network, according to one example;

FIG. 4 is a diagram of a process flow executed by an exemplary content collection system, according to one example;

FIG. 5 is a diagram of a process flow executed by an exemplary content organization system, according to one example;

FIG. 6 is an exemplary table showing types of node connections in a synaptic network, according to one example;

FIG. 7 is an exemplary diagram of nodal connections in a synaptic network, according to one example;

FIG. 8 is an exemplary flowchart of a synaptic network recommendation process, according to one example;

FIG. 9 is an exemplary diagram of a synaptic learning rule, according to one example;

FIG. 10 is an exemplary diagram of a synaptic learning rule, according to one example;

FIG. 11 is an exemplary diagram of a synaptic learning rule, according to one example;

FIG. 12 is an exemplary diagram of a synaptic learning rule, according to one example;

FIG. 13 is an exemplary diagram of a synaptic learning rule, according to one example;

FIG. 14 is an exemplary diagram of a synaptic learning rule, according to one example;

FIG. 15 is an exemplary diagram of a synaptic retrieval rule, according to one example;

FIG. 16 is an exemplary diagram of a synaptic retrieval rule, according to one example;

FIG. 17 is an exemplary diagram of a synaptic retrieval rule, according to one example;

FIG. 18 is an exemplary diagram of a synaptic retrieval rule, according to one example;

FIG. 19A is an exemplary flowchart of a distributed representation recommendation process, according to one example;

FIG. 19B is an exemplary diagram of embedding matrices, according to one example;

FIG. 19C is an exemplary diagram of an item-review context matrix computation, according to one example;

FIG. 20A is an exemplary diagram of a hybrid recommendation model, according to one example;

FIG. 20B is an exemplary diagram of recommendation results, according to one example;

FIG. 20C is an exemplary diagram of recommendation results, according to one example;

FIG. 20D an exemplary diagram of recommendation results, according to one example;

FIG. 21 is a user interface, according to one example.

FIG. 22 illustrates an exemplary architecture of the server according to one example.

FIG. 23 shows a schematic diagram of a data processing system according to one example.

FIG. 24 shows one implementation of a CPU according to one example.

Like reference symbols in various drawing indicate like elements.

### DETAILED DESCRIPTION OF ILLUSTRATIVE IMPLEMENTATIONS

Aspects of the present disclosure are directed to systems and methods for generating recommendations of items for users based on learned relationships between nodes of a synaptic network where the nodes represent users, items, and attributes that describe the users and items. A synaptic network is a type of neural network which operates in a manner that mirrors how neurons, synapses, and neuron circuits operate on a cellular level. Once defined, the nodes of the synaptic network can be linked together using primary information from one or more data sources to initialize connections and provide structured and unstructured knowledge within the network. Structured learning proceeds iteratively throughout the synaptic network to refine weights and probabilities that connect nodes together while also discovering new latent connections. By activating input nodes, the system can retrieve other nodes that are similar to those nodes, in direct proportion to the weighted knowledge that underpins the nodal connections.

### Synaptic Network Recommendation Model

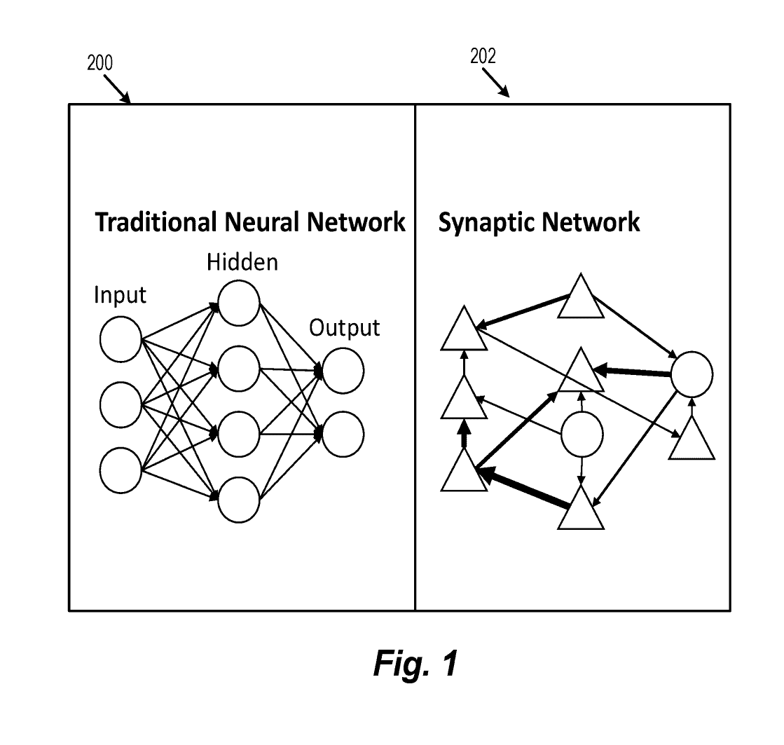

FIG. 1 is an exemplary diagram of a traditional neural network 200 and a synaptic network 202, according to one example. In the traditional neural network 200, a majority of the processing occurs in “hidden nodes” that may not be explicitly identified apart from the preponderance of connections that they statistically recruit. In the synaptic network 202 described in further detail herein, every node within the synaptic network 202 represents an explicit object (for example, a specific wine) or feature (for example, the varietal of the wine), and similarities or differences between the nodes are encoded into the connections or relationships between these objects and features. Once connected, the nodes are able to produce recommendations. For example, a user's tastes can be expressed by activating the nodes for which the user likes or has an affinity and suppressing or inhibiting nodes for things which the user does not like or prefer, which in turn activates other similar nodes based on weighted connections that link the nodes together.

Table 1 illustrates differences in characteristics between the traditional neural networks and the synaptic networks described herein. Unlike previous traditional neural network implementations that abstract around the complexity of true synaptic learning rules, examples described herein provide at least one of a network having a highly recurrent structure, feedback dominant transmission, unsupervised learning style, bottom-up organization hierarchy, a local optimization level and synaptic learning rules. The network can include multiple nodes in which every node represents an item, attribute, or person (reviewer) having connections with other nodes that encode similarities and differences. The network can provide a probabilistic approach where each factor and connection in the knowledge graph can take on a continuous range of weights, and these weights are constantly being refined and nuanced by learning. In select examples, sparse coding is implemented to provide enhanced storage capacity and information retrieval.

TABLE 1

| | Traditional Neural | |
|---|---|---|
| | Networks | Synaptic Networks |
| Structure | Sequential layers | Massively recurrent |
| Dominant | Feedforward | Feedback |
| transmission | | |
| Learning style | Supervised | Unsupervised |
| Organization | Top-down | Bottom-up |
| Optimization level | Global | Local |
| Learning | Backpropagation/gradient | Synaptic learning rules |
| mechanism | descent | |

For any network of relationships, the weights of the connections between nodes are a factor in determining an accuracy of the inferred relationships. To determine the connection weights, rather than supervised learning, the synaptic network 202 uses synaptic learning rules at the cellular and local network level. The connection weights are determined in a bottom-up manner, which means when a connection is made or updated between two or more nodes, the connection is initially made or updated on a local level between the directly affected nodes, and then effect of the connection is subsequently propagated into higher levels of the nodal connections in the synaptic network 202. In addition, the synaptic network may not rely on repetitive retraining because the results in the synaptic network 202 emerge directly from the primary data harvested from one or more data sources and does not rely on “known” data to measure against in order to prepare for deployment of the network.

In addition, recommendations can be made with the synaptic network 202 by activating only a subset of nodes within the synaptic network 202, which corresponds to a principle that biological organisms can include collective properties of systems having large numbers of simple equivalent components. The synaptic network 202 is massively recursive, which means that activation of a subset of the network can evolve through a state space to “resolve” the set of activated nodes that is most parsimonious with the input. In this way, an initial activation of a subset of nodes in the synaptic network 202, followed by asynchronous parallel processing accurately yields an entire memory from any subset of sufficient size, which can be equivalent to activating the items that a user likes and surfacing new items as recommendations. Because of the recurrent structure of the synaptic network 202, information can be cross-connected at multiple loci of relevance and can impact a recommendation decision at different stages and with different interactions. In addition, nodes within in the synaptic network 202 produce decisions based on many probabilities weighed in parallel, and a system controlling the synaptic network 202 reaches decisions based on consensus across the numerous factors represented by the synaptic network 202, which may be more accurate than a decision that has been reached through piecemeal processing or sequential binary decisions. In addition, the connections between the nodes of the synaptic network 202 are probabilistic, not “binary,” and each factor and connection in the network 102 can take on a continuous range of weights, and the weights are constantly refined and updated by synaptic learning rules.

The implementations of the synaptic network 202 described herein also include sparse coding characteristics that provide efficiency in terms of storage capacity and also provide an explicit way to directly read out information encoded into the connections between the nodes. This explicit encoding is particularly useful for business applications or other implementations in which the reasons behind the recommendation or prediction are important to know. For example, traversing a graph where the nodes are labeled, and the weights between the labeled nodes and the result node are quantified may provide more meaningful results regarding reasons behind the recommendation or prediction. In addition, even while the final output recommendation is sparse, there can be a large amount of synaptic activity that drives the result due to a balanced interaction of node/connection excitation and inhibition. In some implementations, the synaptic network 202 is able to evaluate multiple nodal associations in parallel.

Another advantage offered by the implementations of the synaptic network 202 described herein is retraining issues can be bypassed by explicitly representing knowledge as the nodes themselves. For example, learning that a reviewer changed his or her mind about a restaurant, the system can simply update a single connection between the reviewer and the restaurant, and update adjacent connections according to the synaptic learning rules described further herein.

In certain implementations a recommendation engine may generate recommendations based on attributes and data associated with venues, users, reviewers and reviews. The system may harvest reviews generated by various reviewing entities and parse those reviews into an organized database of review data. That data may include attributes of the venue (such as a restaurant) and the rating or assessment provided by the reviewer. The system may also gather or generate data concerning the attributes of reviewer, such as gender, age, profession, marital status, review frequency and review accuracy. The system, in one implementation, also gathers data concerning the attributes of user, such as gender, age, profession, marital status, and affinity (whether positive or negative) for certain venues.

The neural network of interrelationships grows dynamically as further review, reviewer, attribute, and item data is added. The system may continuously analyze the data to add and/or modify weighted connections between the nodes of the synaptic network. The system may create new derivative links, normalize the data to adjust for data skew, and adjust links based on neighboring link values.

In various implementations the system may generate recommendations based on user attributes and data associated with a recommendation request. The system may provide a plurality of recommendations based overall connection strengths that factor in the synaptic learning rules and the synaptic retrieval rules discussed in further detail herein. The recommendations may include venues and other types of items complementary to that specifically requested, for instance, in response to a user request for a restaurant recommendation the system may generate a theater or night club recommendation as well.

Other aspects of the present disclosure are directed to generating recommendations for users through a neural recommender that uses a distributed representation model of items and reviews (feedback). In some implementations, the neural recommender can outperform alternating least squares (ALS) matrix factorization algorithms without requiring parameters that are proportional to the number of users. In addition, a hybrid of the distributed representation model can be implemented that incorporates a probabilistic network of items and their attributes, such as the synaptic network 202. The hybridization allows explicit representations of attributes of items to be maintained, which enables recommendations to be made for items that have not received any reviews. This hybrid model can be implemented in situations where there are large amounts of feedback or in cold start conditions where many items have no reviews.

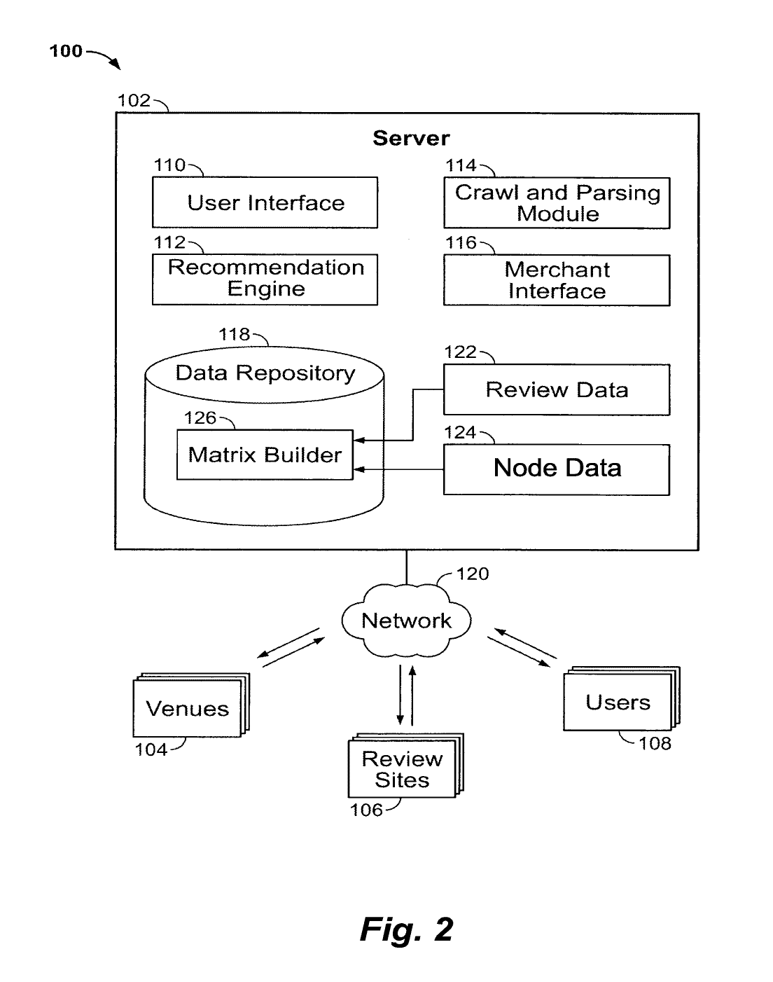

FIG. 2 illustrates an exemplary network architecture for a server-based recommendation generation system 100 that implements the functionality described herein. It will be understood that some or all of the functionality described herein may be relocated to a client device application (such as a smart phone application) based on the client device's communication, data storage and computational capabilities.

The server 102, representing one or more servers, hosts a plurality of engines and modules that include processors with processing circuitry configured to execute one or more software processes of the engines and modules. In this application the user interface module 110 resides on the server 102 and serves web pages or suitable content to a client side application. The crawl and parsing module 114 executes the web crawling and source data collection operations described below. The web crawling and source data collections performed by the crawl and parsing module 114 that are described herein are merely exemplary, and other types of information gathering can also be performed. For example, the crawl and parsing module 114 can be configured to crawl through server nodes or data repositories to access item, attribute, and rating data. For example, the server nodes and data repositories crawled by the crawling and parsing module 114 may be product and review data stored by a particular merchant. The recommendation engine 112 accesses the matrices of interrelationships and generates the recommendations according to the techniques described herein. The merchant interface provides the functionality describe below concerning venue operators' interaction with the server and accessing projections and reports generated thereby.

The data repository 118 stores the matrices of interrelationships. The repository includes a matrix builder 126 which builds the data structures reflecting the nodal interrelationships based on review data 122 which is collected from review sites 106 by the crawl and parsing module 114. The matrix builder also incorporates node data 124 for item, attribute, and person nodes collected from users 108, venues 104 and other web pages (by the crawl and parsing module 114) associated with other types of items or attributes. Throughout the disclosure, references to venues can refer to any type of item for which a user has an affinity that can include by is not limited to content, items for purchase, actions, people, decisions, or anomalies to investigate.

The network 120 includes in certain embodiments the Internet or world-wide web. The network may also include proprietary and semi-propriety networks such as cellular data networks, intranets, VPNs, or extranets.

Those skilled in the art will understand that the techniques described herein may be implemented in various system and database topologies and consistent with various computational methodologies. Topologies and methodologies suitable for aspects of various embodiments are described in K. R. Nichols, A Reconfigurable Computing Architecture for Implementing Artificial Neural Networks on FPGA, Master's Thesis, The University of Guelph, December 2003; F. Rosenblati, The Perception: A Probabilistic Model For Information Storage And Organization In The Brain, Psycho!, Rev., 65(6):386-408, 1958; K. Steinbuch and U. A. W. Piske; Learning Matrices and their Applications. IEEE Trans. Electron. Computers; 12:846-862, 1963; J. A Bamden, High-level Reasoning, Computational Challenges for Connectionism, and the Composit solution. Appl. Intell., 5(2):103-135, April 1995; B. Denby, P. Garcia, B. Granado, C. Kiesling, J. C. Prevotet and A. Wassatch, Fast Triggering in High Energy Physics Experiments Using Hardware Neural Networks, IEEE Trans. On Neural Networks, 14(5):1010-1027, September 2003; R. 0. Duda, P. E. Hart, and D. G. Stork. Pattern Classification. John Wiley & Sons, New York, 2nd edition, 2001; H. Eichenbaum, The Cognitive Neuroscience of Memory: An Introduction, Oxford University Press, New York, 2002; K. Fukushima, Cognitron: A Self-Organizing Multilayered Neural Network, Biol. Cybern, 20(3-4): 127-136, 5 Nov. 1975; K. Fukushima and S. Miyake. A Self-Organizing Neural Network With A Function Of Associative Memory: Feedback Type Cognitron, Biol. Cybern., 28(4):201-208, 3 Mar. 1978; J. M. Fuster. Cortex and Mind: Unifying Cognition. Oxford University Press, New York, 2002; R. Gadea, J. Cerda, F. Ballesterand A. Mocholi, Artificial Neural Network Implementation On A Single FPGA Of A Pipelined On-Line Backpropagation, ISSS 2000, Madrid, Spain, September 2000; S. Grossberg, Adaptive Pattern Classification And Universal Recoding: I. Parallel Development And Coding Of Neural Feature Detectors. Biol. Cybern., 23(3):121-134, 30 Jul. 1976; S. Grossberg, Adaptive Pattern Classification And Universal Recoding: IL Feedback, Expectation, Olfaction, Illusions, Biol. Cybern., 23(4):187-202, 30 Aug. 1976; S. Haykin. Neural Networks: A Comprehensive Foundation. Prentice Hall, Upper Saddle River, N.J., 2nd edition, 1999; R. Hecht-Nielsen, Neurocomputing, Addison Wesley, Reading, Mass., 1989; R. Hecht-Nielsen, A Theory Of Thalamocortex, in R. Hecht-Nielsen and T. McKenna, editors, Computational Model!for Neuroscience: Human Cortical Information; S. Y. Kung, M. W. and S. H. Lin., Biometric Authentication: A Machine Learning Approach. Prentice Hall PTR, Upper Saddle River, N.J., 2005; B. Widrow and M. Kamenetsky, On The Efficiency Of Adaptive Algorithms, In S. Haykin and B. Widrow, editors, Least-Mean-Square Adaptive Filters, John Wiley & Sons, New York, 2003; B. Widrow and M. Kamenetsky, Statistical Efficiency Of Adaptive Algorithms, Neural Netw., 16(5-6):735-744, June-July 2003; B. Widrow and M. A. Lehr, 30 Years Of Adaptive Neural Networks: Perception, Madaline, and backpropagation, Proc. IEEE, 78(9):1415-1442, September 1990; U.S. Pat. No. 7,840,569, entitled “Enterprise relevancy ranking using a neural network,” which is incorporated herein by reference; U.S. Pat. No. 7,895,140, entitled “Neural Network Learning Device, Method, And Program,” which is incorporated herein by reference; and U.S. Pat. No. 7,979,370, entitled “Neural Network For Electronic Search Applications,” which is incorporated herein by reference.

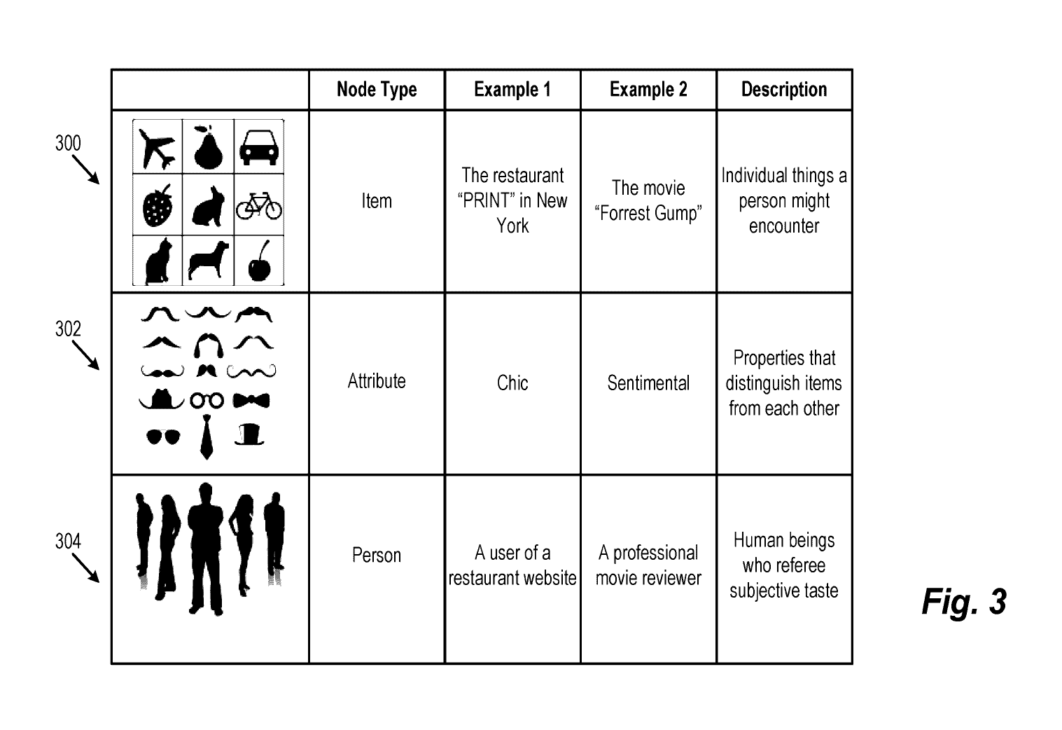

FIG. 3 is an exemplary table showing types of nodes in a synaptic network, according to one example. The nodes in the synaptic network can include items 300, attributes 302, or persons 304. The items 300 can be individual things a person may encounter, such as restaurants, movies, and the like. The system 100 extracts the items 300 from one or more primary data sources (discussed further herein). In some implementations, the server 102 also includes a resolution engine that resolves, combines, and de-duplicates the items 300 extracted from the primary data sources.

In some examples, the items 300 of the synaptic network can be organized into one or more categorical domains based on the type of item 300. For example, the items 300 can include a venue categorical domain that includes restaurants, theaters, night clubs, hotels, concerts and other events. The items 300 in the synaptic network can also include sub-venue items such as specific mend items or specific rooms inside a hotel. The items 300 may also include other categorical domains such as style consumables such as clothing, furniture or wine or rather content such as music, books, magazines, TV shows, or movies. The items 300 can also be services such as mechanics, barbers, transportation, doctors, dentists, landscape architects, interior designers, or nanny services. In other implementations the items 300 may also include neighborhoods or cities in which to live, colleges to apply to, careers that are a good fit, or grocery stores. In still other applications the items 300 may be associated with social aspects such as friends and activities the user might like. In other embodiments, the items 300 may be medical conditions or treatments.

The attributes 302 are nodes of the synaptic network that include properties that distinguish the items 300 from one another. For example, a restaurant may have an attribute of “chic,” or a movie may have an attribute of “sentimental.” The system 100 identifies the attributes 302 and establishes connections between the attributes 302 and items 300 of the synaptic network based on the attributes 302 that are used to describe the items 300 in one or more primary data sources that can include websites, user reviews, and the like. The system 100 also standardizes the attributes 302 to converge on a controlled vocabulary of terms. The attributes 302 of the synaptic network can be connected to the items 300 across multiple categorical domains of the items 300 so that the system 100 can perform cross-category inference to link shared attributes 302 or people 304 who have common experiences with items 300 across different categorical domains.

The person nodes 304 are nodes of the synaptic network that include human beings who referee subjective taste for the items 300. Throughout the disclosure, the person nodes 304 can also be interchangeably referred to as users or reviewers. For example, a person can be a user of a restaurant website or a professional movie reviewer. The system 100 identifies patterns of transactions for each of the users 304 in order to link the users to the items 300 or attributes 302. For example, users 304 can be linked to items 300 through reviews of the items 300. The users 304 can also be linked to attributes 302 through answers to online quizzes, social media profiles, or adjectives used to describe the items 300 in written reviews.

The techniques described herein may also be used for fraud detection by providing predictions of what a user is unlikely to do, which in turn is more likely to be associated with fraudulent use of a credit card (for instance). The techniques may also be used for marketing/co-branding opportunities by predicting brand affinity even across disparate categories. The techniques may also be applied to actuarial/risk assessment applications by analyzing co-occurrences between a user's fine-scale likes and dislikes, which can be utilized as indicators of risk. The techniques may also be used to predict financial market behavior or trends by aggregating markets into “group users” and predicting behavior of that group user as described hereinbelow. In a similar vein predictions on mass human behavior can be achieved with respect to geographic movement (migratory patterns) and thereby census and demographic projections over time may be generated for use by retailers, real estate developers, and others. Moreover, the techniques may be used to gauge affinity for certain types of media (such a television shows) or media channels (cable or web).

Hereinbelow the system 100 is described in connection with exemplary systems in which the item nodes 300 are venues such as restaurants, hotels or theaters. For convenience the term “venue” is used to refer to the synaptic network nodes. It should be understood that the term “venue” in the following sections is used broadly to refer to any entity or item that is interrelated in the network with other network nodes such as person nodes 304 or attribute nodes 302.

A user's or reviewer's affinity (again, positive or negative) for a venue is derived from both evaluations and assessments of venues, such as reviews or ratings, and implicit data sources such as ant trails. Individuals may publish ratings on social webpages, review forums and websites or blogs. Ratings may also be published by votes placed via “Like” or “Ding” buttons disposed on various websites. As one example, user reviews of restaurants can be found at menuism.com, dine.com, opentable.com, google.com, reviewsahoy.com, and realeats.com. An individual's affinity for certain venues can also be discerned from their spending habits or purchase history, data of which can be gleaned from financial transaction records such as credit card statements. An individual's web browsing history or ant trail can also provide insight into affinity for certain venues, as discerned from cookies or the various reviews an individual generates across multiple forums, including but not limited to web sites associated with each venue. An individual's website navigation bookmarks and browsing history also reflect browsing behavior and may likewise be mined for source data. The geographic position of an individual over time, such as derived from cellular GPS data, can likewise be correlated with venues and thereby generate data reflective of venue affinity. This approach may provide dwell time data as well, which can be used to sort or arrange the data. Magazine subscriptions information may also be used as indicators of an individual's affinity for given venues (as that term is broadly used herein). An individual's professional licenses can also be used as data sources for affinity for venues, including but not limited to organizations.

The foregoing sources of data concerning venue affinity can be prioritized based on factors germane to the strength of the correlation between the data and the affinity of interest. Data or sites that refer to a greater number of venues might be more probative since such sites are more likely to compare, contrast or rank venues. Similarly, sites that specify a greater number of properties, such as in structured fields, for each venue or reviewer tend to be more effective or probative. Sites with a greater number of reviews per venue and/′ or reviews per reviewer are, on balance, to include more reliable affinity, The inclusion of “related items,” “also viewed,” or “people who purchased this also purchased” fields or boxes can also be considered as indicators that the site's data will be strongly correlated to actual affinities. In a similar vein, a site's inclusion of geographically proximate recommendations, recommendations based on social networking, and recommendations based of complementary venues (e.g. hotel and restaurant) may be indicative of more reliable data. The behavior of the more effective or accurate reviewers also can be analyzed to differentiate various data sources, for example, by determining where those reviewers tend to post reviews. The existence of grouping structures, such as data structures associated with a plurality of socially networked individuals, can also be used as a metric to grade or rate the potential value of the site's data. Blogs may also be crawled to determine which reviews or ratings sites are the most commonly referenced.

In one example, numeric values are associated with some or all of the foregoing variables and weights are assigned to each variable based on the system designer's estimation of the relative strength of correlation between the variable and the predictive value of the review data on the site. For instance, the density of the best reviewers on a site may be weighted more heavily than the number of venues referenced on a site. The resulted weighted numerical grades can be used to prioritize harvesting operations.

The reviews may be harvested using web crawling techniques such as those described in U.S. Pat. No. 6,631,369, entitled “Method and System for Incremental Web Crawling” and assigned to IBM Corporation, which is incorporated herein by reference. According to that technique, in an initial crawl, the crawler creates a first full index for the document store after which incremental crawls are executed.

Alternatively or in addition, the system 100 may target cached web pages served by commercial search engines. A suitable protocol for rebuilding content sites from search engine caches is as follows. First, a complete venue listing for a category is determined by crawling a directory such as a Yellow Pages or other suitable directory. For each item in the directory, the system 100 runs a series of search queries in various search engines, each query restricted to results for the content site of interest, such as dine.com. The search results are parsed and the URLs for the relevant cached pages are retrieved. The cached pages are then retrieved and in a repository, after which they are parsed based on the name, city, phone number, and other data fields associated with a venue of interest. In this manner the cached review page for the venue of interest may be identified. This process is optionally repeated across search engines and across multiple venues, targeting the sites prioritized as set forth in the preceding section, to collect the desired array of source data.

The data may optionally be validated by checking parsed venue or reviewer content for blank fields. Venue or reviewer content may also be checked against unique identification information (a venue phone number or a reviewer email address or screen name) to ensure sure that it corresponds to the target venue or reviewer.

After validation, the pages may be parsed to extract the data of interest. Parser code may be used to segregate out the structured fields of interest, the reviews, and other information of interest as described above. The extracted data may be upload the data in database tables or files to be analyzed for computing personalization. Techniques such, as those taught in U.S. Pat. No. 7,788,293, entitled “Generating Structured Information” assigned to Google Inc., the contents of which are herein incorporated by reference, may be used for this purpose.

The same approaches can be used to harvest data concerning reviewers or users. The data is preferentially in a structured format on a public site and is predictive of personality and affinities. The data sources may be prioritized or ranked as set forth in the preceding section, such as according to the number of reviews, given by the reviewer, the citation of a reviewer's reviews on other sites and the alignment of a reviewer's reviews with overall ratings generated by the system 100 and third party review sites from which data is harvested. The reviewer data is then selectively crawled and parsed as explained above.

The crawl and parser module 114 may be configured to coordinate the crawling and digestion of certain web or network nodes. Due to practical limitations the entire World Wide Web cannot be crawled and parsed simultaneously. The crawling and parsing process may be coordinated across different content-gathering computers or agents. Multiple remote crawling engines (at remote network nodes) may be deployed, each of which can check data sources (such as web pages or cached web pages) for the properties described above and recruit crawling and parsing nodes in the event rich data sources are located. The remote crawling nodes can coordinate their crawling based on real-time breaking news events, or optimize content gathering in response to shifts in mass user behavior as reflected in the data matrices described herein.

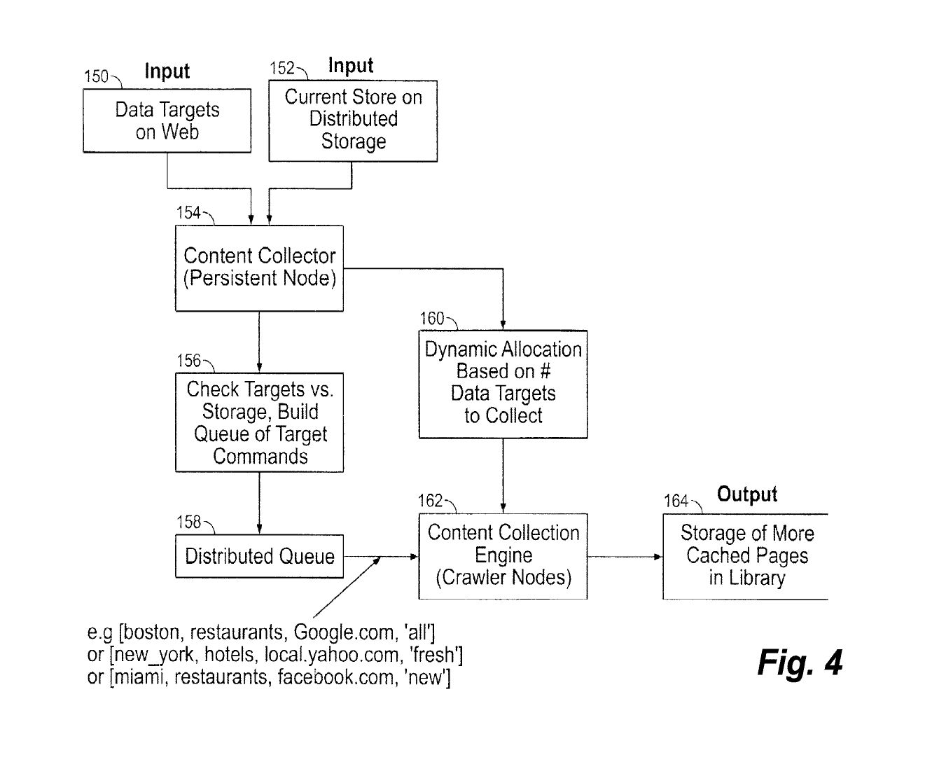

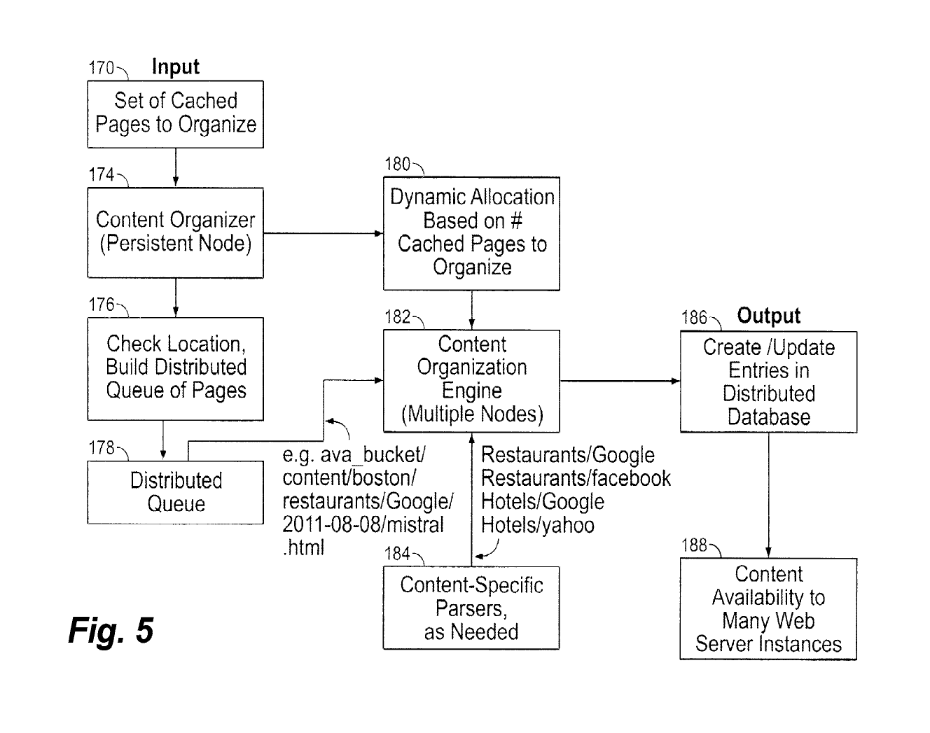

Examples of content collection and content organization systems and process flows are shown in FIGS. 4 and 5. FIG. 4 illustrates the process executed by the content collection system, which may include the crawl and parsing module 114. At box 150 the crawl and parsing module 114 identifies subject matter targets, such as rock-climbing, are needed in the neural network. The targets may also take the form of specific URLs or collections thereof. At box 152 the module 114 identifies the current content, in the form of previously collected web pages (or representations thereof), that already resides within the system's storage network. At step 154 the content collector, which in one embodiment takes the form of a persistent system network node, determines from a comparison and analysis of the two inputs which subject matter or URLs are to be gathered by the module 114. The content collector verifies the addresses and content of the target sites containing the subject matter which is to be collected and creates a queue of items to be crawled and parsed by the module 114. As an example, the distributed queue's first entry might be [Boston, restaurants, google.com, ‘air] which corresponds to a request that the crawler nodes collect all cached pages associated with google.com's reviews of any Boston area restaurant. The content collector may also dynamically allocate certain queue items to specific crawling nodes based on their relative priority (160). At step 162 the content collection engine, which includes a distributed array of crawler nodes, receives or access the distributed queue and dynamically assigned collection commands from the content collector. The content collection engine, under the control of crawl and parsing module 114, collects cached web pages as discussed above. The output is a library of cached web content which is parsed according to the methods described herein.

FIG. 5 shows an exemplary process executed by the content organizer, which may include the matrix builder 116. At step 174 the content organizer receives or accesses the library of cached pages to be parsed and added to the network. The content organizer may be a persistent system network node in various embodiments. The content organization engine (see step 182) may include a distributed array of parsing nodes that access a distributed queue of parsing assignments and receive assignments which are dynamically assigned, optionally to specific crawling nodes or crawling nodes having certain attributes such as bandwidth or throughput. The content organization engine also accesses an array of site-specific parsers which are specially designed to parse data as it is presented on certain sites. For instance, because Google.com may present its hotel data in a format different than restaurants, a parser engine specific to Google's hotel pages is presented to the content organization engine for use in parsing corresponding cached web pages. Other examples, as shown in FIG. 5 include a parser specific to Facebook.com's venue or event pages. This architecture may facilitate modification of parser engines as sites alter the manner in which they present data. For example, Local.yahoo.com may alter the data format of its hotel pages, in response to which a single parser engine can be updated. The output of the content organization engine (182) is used by the matrix builder 114 to create additional nodes and matrices of interrelationships as described herein. The resulting matrices and databases of web content are presented for simultaneous access by multiple instances of web servers which present the user interface described below or which communicate with mobile device client applications as discussed herein.

Upon creation of an account or in response to another triggering event such as a request for a new recommendation the system 100 may require a user to input various data including gender, age, marital status, children ages, children gender, third parties with whom the user is socially networked, hobbies, interests, favorite venue information (in one or more item or venue categories), preferred or non-preferred reviewing entities (if any).

The user is then asked to list favorite or preferred items. As an example, the user may list favorite restaurants. The system 100 asks for alternative favorites in the event the restaurant is not included within the neural network.

The system 100 optionally may crawl the web for additional information concerning the user and then parse and validate the data according to the methods described above. This supplemental data may be added to the user's profile, data from which will be used in various operations as set forth below.

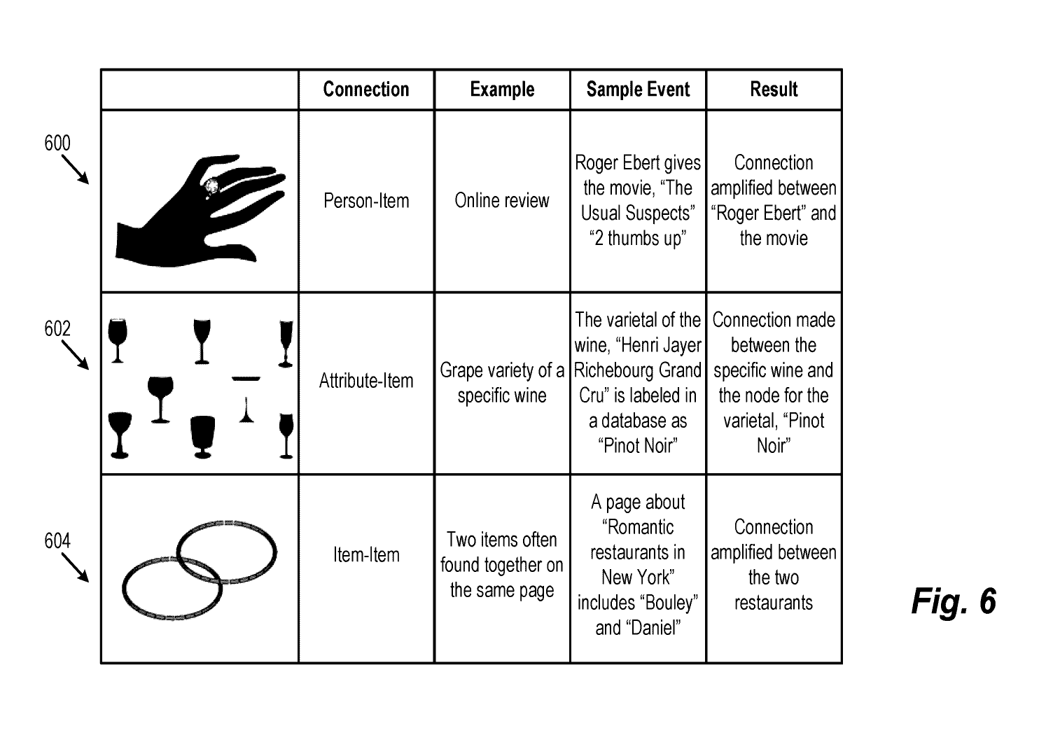

FIG. 6 is an exemplary table showing types of node connections in a synaptic network, according to one example. The connections or links between the item nodes 300, attribute nodes 302, and person nodes 304 represent relationships between those nodes. The number of connections or connection strength between two nodes might therefore grow as data on two items grows. The strength of each connection denotes the affinity between the two connected nodes, such as similarity of star rating (in a review of an item) or a number of attributes held in common. The connections can be either positive or negative in sign and can have varying weights that represent the strength of the affinity between the connected nodes. The connection strengths between the nodes are based on an application of one or more synaptic learning rules to the nodal connections in the synaptic network as will be discussed in further detail herein.

In some implementations, the connections can include person-item connections 600, attribute-item connections 602, item-item connections 604, and person-attribute connections (not shown). Person-item connections 600 can represent a connection between a reviewer and an item, such as an online review of a movie by a movie reviewer. Attribute-item connections 602 represent specific properties or descriptive terms of attribute nodes 302. For example, an attribute of a specific wine can include a grape variety of the wine, such as Pinot Noir. Item-item connections 604 represent an amount of similarity between two items, such as two restaurants that are classified as “romantic” on a restaurant search website. Person-attribute connections represent an affinity of a person for a particular attribute. For example, a person who provides positive reviews for Italian restaurants and Italian wine can have a connection with an “Italian” attribute node. By connecting the item nodes 300, attribute nodes, and person nodes 304, item, attribute, and person classes of knowledge can be incorporated into a single recurrent network. For example, a specific movie can be connected to reviewers of that movie as well as attributes that define the movie, which in turn can connect the items to attributes and reviewers of other movies, books, etc.

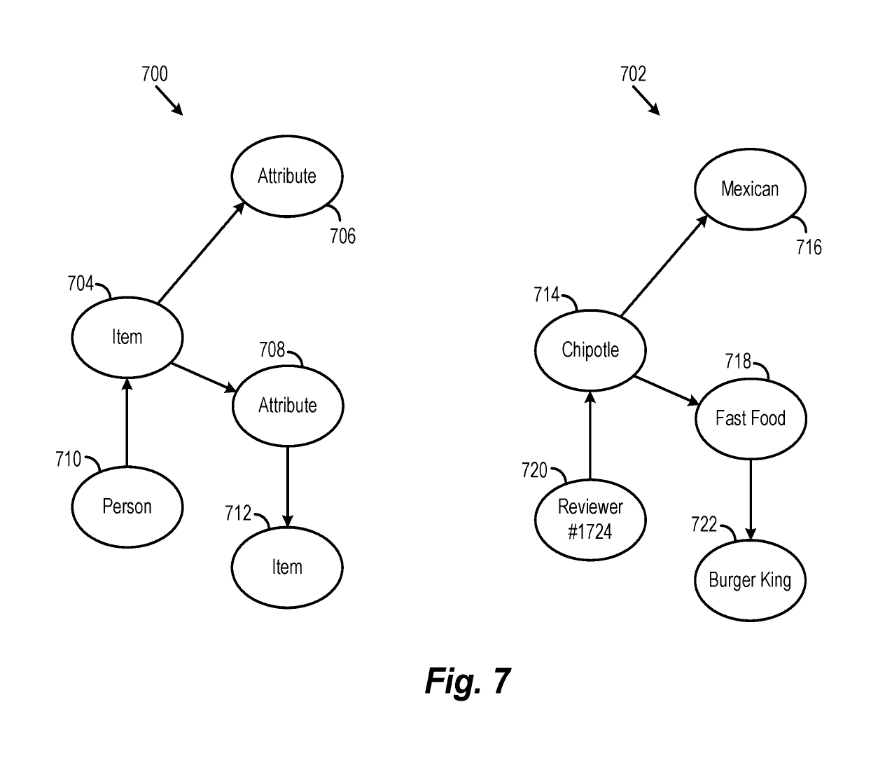

FIG. 7 is an exemplary diagram of nodal connections in a synaptic network, according to one example. Regardless of the category of knowledge being described by the synaptic network, the nodes represent items 300, attributes 302, or persons 304. Graph 700 represents general nodal connections between items nodes 300, attribute nodes 302, and person nodes 304. For example, item 704 is connected to attributes 706 and 708 as well as person 710, and the attribute 708 is connected to item 712. Graph 702 represents a specific example of the graph 700. For example, item 714 corresponds to the restaurant Chipotle, which is linked to attribute 716 of Mexican and attribute 718 of fast food, which are both characteristics of types of foods served by Chipotle restaurants. Also, person node 720 corresponds to a reviewer #1724 who has provided a restaurant review for Chipotle, which may indicate that the reviewer #1724 has an affinity for the food served by Chipotle. The graph 702 also includes an item node 722 for Burger King, which is also connected to the attribute node 718 of fast food.

The synaptic network provides a general, domain-independent, representational infrastructure. For example, the synaptic network is extensible in that the attribute nodes 302 of the synaptic network can be connected to the item nodes 300 and person nodes 304 across multiple categorical domains of the items 300 so that the system 100 can perform cross-category inference to connect shared attributes 302 or persons 304 who have common experiences with items 300 across varied categorical domains. The synaptic network is also maintainable in that the database mechanic and learning rules applied by the system 100 to the synaptic network can be developed, modified, and maintained in one place within the server 102, such as in the data repository 118, but can be applied scalably to all categorical domains of the synaptic network. The synaptic network is also connectable so that lower-order feature extraction engines (e.g., document parsing, semantic analysis, image annotation) can be applied equivalently to the synaptic network across all of the categorical domains. Similarly, higher-order knowledge distillation and analysis functions can also be applied to all domains of the synaptic network.

The nodal structure facilitates computations and scaling of the network. The synaptic network creates a natural look-up table that is convenient to search and operate over. The nodal structure with inter-node links of varying types provides a convenient way to update the structure as new pieces of information are added, and in certain examples this is executed without losing the original information as in traditional databases that represent affinity as single number weights between items. The data in various embodiments is represented as either an indexed rows of databases, linked lists, or distributed files.

Either the system or users may trigger the recommendation engine. The users may do so by entering through a web portal, client application or electronic message a request that a recommendation be generated based on provided venue attributes such as type, geography or price. The system 100 may access a user profile to collect data from the user profile such as other venues liked, gender, profession, or age. The system 100 may also automatically generate recommendations for inclusion in electronic messages, such as text messages or email messages, sent to targeted users or for presentation on a web portal or client application accessed by users.

The recommendation engine responsively identifies the venues with strongest connections according to the following protocols in selected embodiments. Based on the identified “liked venue(s)” the system 100 identifies the top N venues that have strongest link value to that the identified venue and which have the specified venue attributes. Alternatively or in addition, based on highest rated venue(s) having specified attributes the system 100 identifies the top N venues that have strongest link Value to that the identified venue. Still another alternative which can be used alone or in combination with the foregoing is to, based on the highest rates venue(s) having specified attributes and being recommended by friends or selected reviewers, identify the top N venues that have strongest link value to that the identified venue. The recommendation engine may also generate recommendations based on the user's attributes, for instance by identifying the top N venues that have strongest link to user attributes.

In certain embodiments, a plurality of these techniques are used and resulting venue recommendations are weighted based on empirical observations concerning the predictiveness or accuracy of each protocol. The weight factors may be simple coefficients or first, second or higher order equations.

In the case of recommendations provided for a group of users, these same techniques may be used but with the modification that the user attributes are selected to match the group, either by direct user input or by arithmetic blending or averaging the user attribute values to arrive at a composite group user profile.

Recommendations may also be provided based on real-time location information, such as that provided by smart-phone GPS data. As described more fully below, the system 100 may send an electronic message or alert either including a recommendation based in part on the location and/or time or prompting the user to access an interface to receive the recommendation. For instance, if a user is known to be proximate to a theater shortly before a show which the recommendation engine ranks highly for that particular user the system 100 may generate an electronic alert to the user including the recommendation, a hyperlink to the system 100 web portal, or a link to active a client recommendation application which can launch the interface described herein.

Alerts or recommendations may be accompanied by, and be generated based on, promotional offers related to the venues. For instance, an electronic notification may contain a recommendation along with a promotional discount offer for the related potential booking or reservation. Recommendations presented in the interface (or via electronic messages) may also be selected based in part on promotional status. That is to say, the recommendation engine may strengthen links nodes associated with promotional offers and thus the engine will factor in promotional offers when determining nodes to recommend (i.e. those most strongly linked to nodes associated with the user or a recommendation request).

Users' feedback concerning recommended venues and the associated “take rates” may likewise be factored in by the recommendation engine. For example, the link strengths may be increased for venues for which users more frequently make reservations based on the recommendations, consistent with the techniques taught herein.

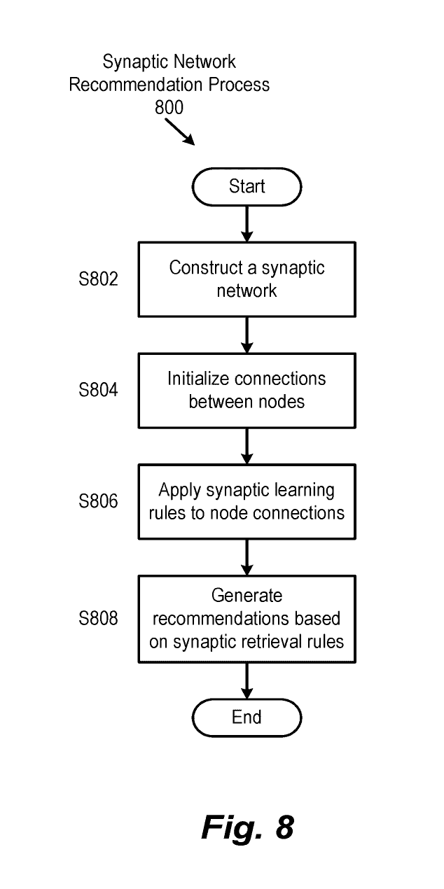

FIG. 8 is an exemplary flowchart of a synaptic network recommendation process 800, according to one example. In some implementations, the synaptic network recommendation process 800 is performed by the recommendation engine 112 of the server 102 but could also be performed by any processor of the system 100 that has processing circuitry configured to execute the processes described further herein.

At step S802, the system 100 constructs a synaptic network that includes defining item nodes 300, attribute nodes 302, and person nodes 304 from one or more primary data sources, such as webpages, review sites, social media pages, and the like. The data included in the synaptic network is collected by the content collection system and organized by the content organizer discussed previously herein.

At step S804, connections between the nodes of the synaptic network are initialized based on relationships between the item nodes 300, attribute nodes 302, and person nodes 304 that are identified from the primary data sources. For example, if a webpage for a restaurant indicates that the restaurant serves Italian food, then a connection can be initialized between an item node for the restaurant and an attribute node for “Italian.” The item nodes 300, attribute nodes 302, and person nodes 304 are included in a single recurrent synaptic network graph and can be connected across multiple categorical domains. In addition, the connections between the nodes are explicit representations of the interrelationships between items, attributes, and people.

At step S806, the system 100 applies one or more synaptic learning rules to the connections between the nodes to modify the connections and connections strengths between the nodes of the synaptic network. In some implementations, the connection strengths between the nodes are weighted probabilities that represent an amount similarity or affinity between the nodes. The synaptic learning rules applied to the nodal connections correspond to ways in which neural circuits operate on a cellular level to capture information and represent the information for long-term storage and synthesis across time. The connection weights are determined in a bottom-up manner, which means when a connection is made or updated between two or more nodes, the connection is initially made or updated on a local level between the directly affected nodes, and then effect of the connection is subsequently propagated into higher levels of the nodal connections in the synaptic network. Details regarding the synaptic learning rules are discussed further herein.

In addition, when the synaptic learning rules are applied, the system also constructs inhibition nodes within the synaptic network to manage relative numbers of nodal activations among various categories and sub-categories within the synaptic network. The inhibition nodes are another type of node within the synaptic network in addition to the item nodes 300, attribute nodes 302, and person nodes 304. In some implementations, the system 100 generates the inhibition nodes with connections to other nodes within the synaptic network based on categorical groupings of the nodes. For example, an inhibition node may be generated for restaurants that have an attribute of “sushi,” and another inhibition node may be generated for restaurants that have attributes of “fancy” and “sushi.” The inhibition nodes act as control nodes to manage numbers of activations and connection strengths within the synaptic network. For example, if “fancy sushi” restaurants account for greater than a predetermined number of activations within the synaptic network compared to other types of restaurants, then the inhibition nodes can balance the number of activations within the synaptic network so that the connection strengths to “fancy sushi” restaurants do not dominate the recommendations generated by the recommendation engine. In one implementation, an inhibition node is generated for a particular category or sub-category of nodes if a number of activations is greater than a threshold. For example, the “fancy sushi” inhibition node may be generated when a number of activations related to fancy sushi restaurants represents greater than 10% of the total restaurant activations within the synaptic network.

At step S808, the system 100 generates recommendations for a user based on one or more synaptic retrieval rules. In some implementations, a user may input a recommendation request for a particular type of item at a user interface screen of a client device. By identifying one or more input nodes in the synaptic network applying the synaptic retrieval rules, other similar nodes can be identified in direct proportion to the connection weights associated with the nodal connections. To retrieve a recommendation for a user, the recommendation engine of the system 100 identifies one or more items that the user likes, and the recommendation engine also retrieves other items that they may possibly like by leveraging the relationships between attributes and historical people that are embedded in the connection weights of the synaptic network. For example, the recommendation engine identifies recommended items for the user by amplifying relationships between nodes for which the user has an affinity or likes and suppressing relationships between nodes associated with items or attributes that the user does not like.

In some implementations, the synaptic network can include one or more inhibition nodes that scale and sharpen the recommendation results to reduce spurious recommendation results, which produces a more sparse recommendation set. For example, inhibition nodes can receive their own connections, which can compete and be synthesized just like excitatory nodes. The synaptic retrieval rules implement both subtractive and division inhibition as will be discussed further herein.

In addition, to predict whether the user has an affinity for an item or whether an attribute accurately describes an item, the recommendation engine can determine a strength of the resulting activation, to determine a quality of the connection. The synaptic network can also be used to determine reasons for a match, which results from encoding knowledge into the nodes explicitly. Details regarding the synaptic retrieval rules are discussed further herein.

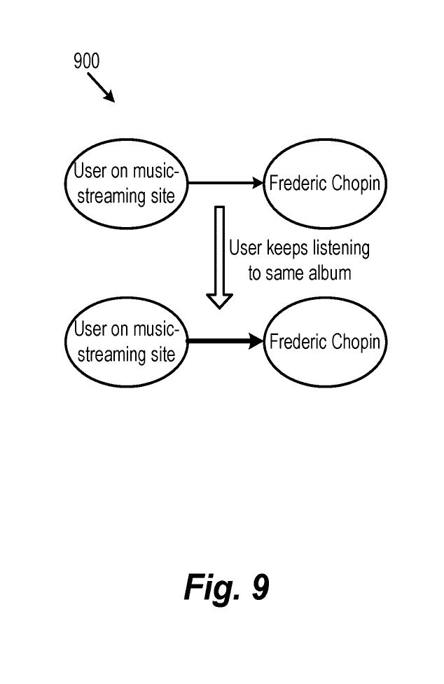

FIGS. 9-14 are exemplary diagrams of synaptic learning rules applied at step S806 of the synaptic network recommendation process 800, according to one example. The system 100 can apply one, several, or all of the synaptic learning rules when determining the relationships between the nodes of the synaptic network. FIG. 9 is an exemplary diagram 900 of an association synaptic learning rule, according to one example. According to the association synaptic learning rule, connection strengths between two or more nodes can be strengthened when the nodes are activated within a predetermined period of time that indicates that the nodes are closely related in time as well as context. Throughout the disclosure, references to activation of nodes can indicate instances of the information represented by the nodes being extracted from webpages, review sites, social media profiles, and the like. For example, if a user repeatedly goes to a restaurant, then the user node and the restaurant node are repeatedly activated within a predetermined period of time, and the connection strength between the restaurant and the user is strengthened, which means that the connection weight between the restaurant and the user is increased. In a similar way, a connection strength between a user and composer Frederic Chopin is increased as the user repeatedly listens to a Frederic Chopin album on a music streaming website. Also, the connection strength between two restaurants can be increased if the two restaurants repeatedly appear on webpages together.

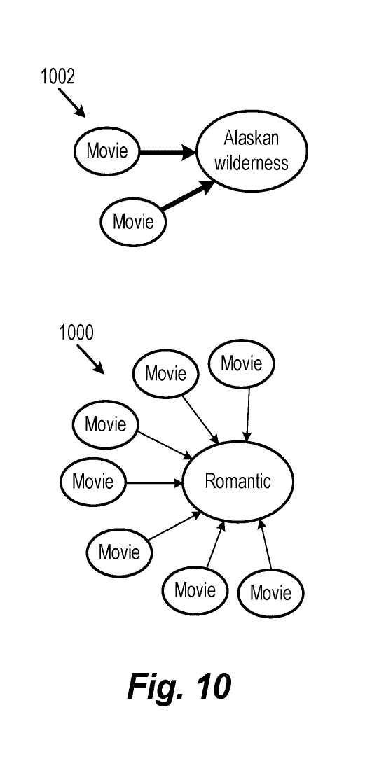

FIG. 10 includes exemplary diagrams 1000 and 1002 that illustrate a synaptic learning rule where unitary connection strength is based on a number of nodes that are connected to a particular node, according to one example. In some implementations, when a node is connected to many partner nodes, the strength of each connection to the partner nodes is more weakly distributed than for a node that is connected to fewer partner nodes. For example, the diagram 1000 shows that an attribute node for “romantic” is connected to a larger number of movies than a number of movies connected to an attribute node of “Alaskan Wilderness” as shown by the diagram 1002. Therefore the connection strengths between the movies classified as “romantic” and the “romantic” attribute node are more weakly distributed than the connection strengths classified as “Alaskan Wilderness” and the “Alaskan Wilderness” attribute node, which indicates that movies set in the Alaskan Wilderness are more rare than romantic movies, which may indicate a stronger connection.

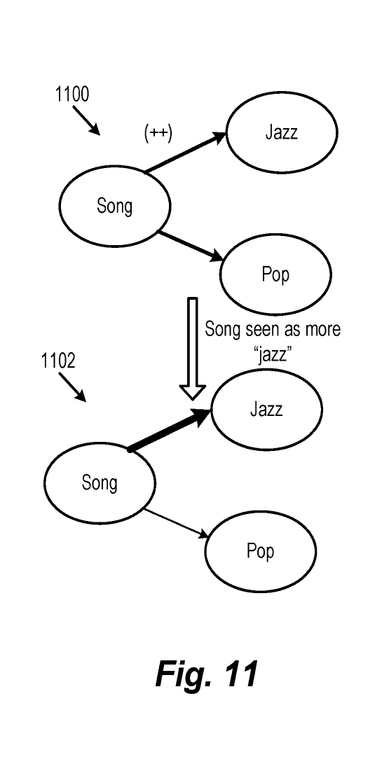

FIG. 11 includes exemplary diagrams 1100 and 1102 of a heterosynaptic competition synaptic learning rule, according to one example. According to the heterosynaptic competition synaptic learning rule, a node has to make tradeoffs with respect to connection strength distribution so that increasing the strength of one of the node's connection to another node results in weakening the strengths of the other connections to the node. In addition, decreasing the strength of one of the node's connection to another node results in increasing the strengths of the other connections to the node. As shown in diagram 1100, a particular song node has connected attribute nodes of “jazz” and “pop.” Increasing the connection strength between the song node and “jazz” node results in the connection strength between the song node and “pop” node being weakened, as is shown by the diagram 1102. In addition, if a restaurant is labeled as “French,” “Italian,” and “Pizza”, and the system 100 collects additional data that results in the system 100 learning that the restaurant is more “French” than previously thought, then the connection strengths between the restaurant and the “Italian” and “Pizza” nodes are reduced.

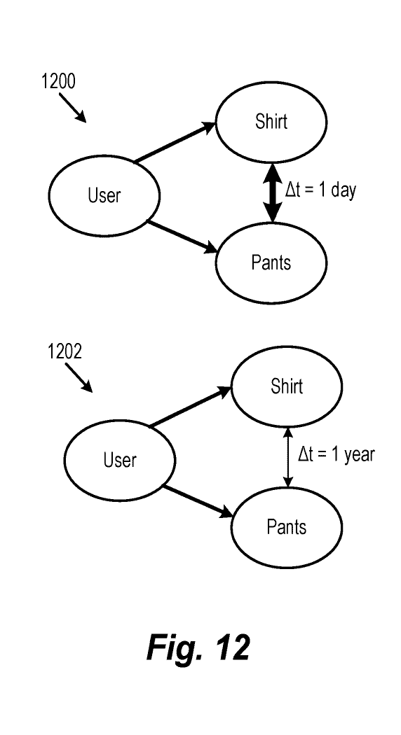

FIG. 12 includes exemplary diagrams 1200 and 1202 of a timing relationship synaptic learning rule, according to one example. According to the timing relationship synaptic learning rule, nodal activations that occur closer together in time have a stronger connection than nodal activations that occur further apart in time. As shown in the diagram 1200, a connection strength between a shirt and a pair of pants purchased by a user in one shipment (Δt=1 day) is stronger than a connection between a shirt a user pair of pants purchased by a user in different calendar years (Δt=1 year) as shown in the diagram 1202.

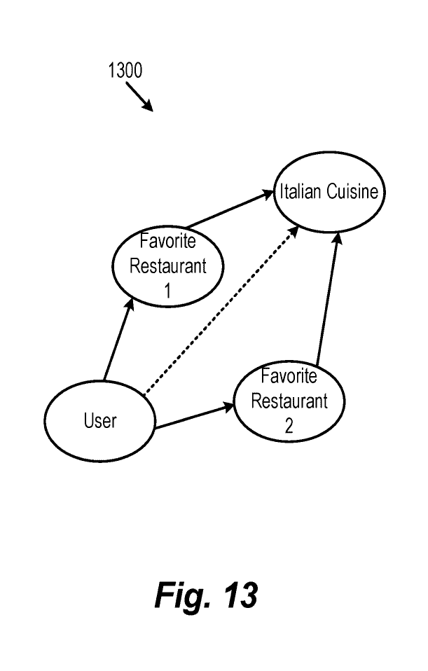

FIG. 13 is an exemplary diagram 1300 of an inference and capture synaptic learning rule, according to one example. According to the inference and capture synaptic learning rule, the system 100 can consolidate nodes that are indirectly connected in chains into direct connections. As shown in the diagram 1300, if a user likes a favorite restaurant #1 and a favorite restaurant #2 and both of the restaurants are Italian restaurants, then the system 100 can establish a connection between the user and an “Italian” attribute node.

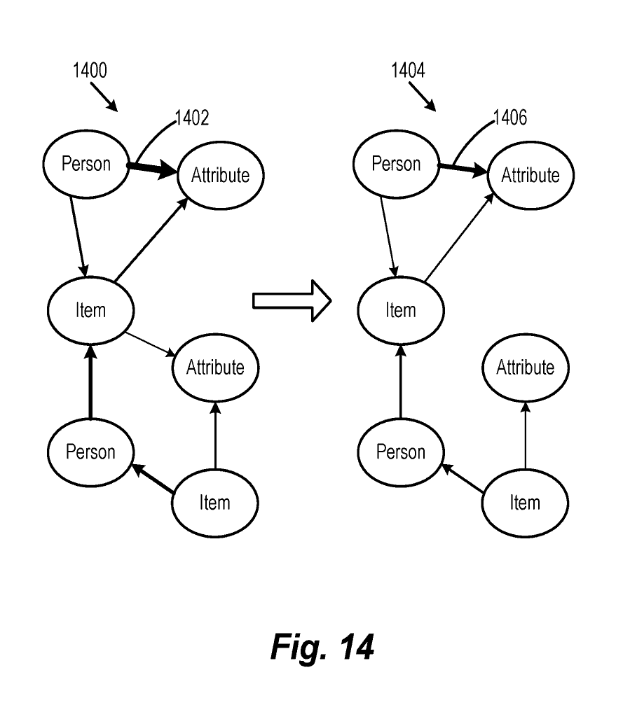

FIG. 14 includes exemplary diagrams 1400 and 1404 of a global synaptic scaling synaptic learning rule, according to one example. According to the global synaptic scaling synaptic learning rule, if an average connection strength between two or more nodes becomes greater than a predetermined threshold or less than a predetermined threshold, then the connection strengths can be scaled down or scaled up the strengths of all synapses uniformly to preserve relative connection strengths between the nodes. In one example, the recommendation engine maintains a global counter that tracks a total number of activations within the synaptic network and scales the connection strengths between the nodes based on a current value of the global counter. If an item category exists with a number of nodal connections that is greater than the predetermined threshold which may be a percentage of the current value of the global counter with associated attributes and users, such as restaurants in New York City, then the connections for the item category can be scaled down in strength to balance the connections with respect to other category domains. For example, diagram 1400 shows that if a strength of a connection 1402 between a person and attribute becomes greater than the predetermined threshold, then one or more of the connections that are directly or indirectly associated with the connection 1402 are scaled down so that the strength of connection 1406 in the diagram 1404 is less than the predetermined threshold.

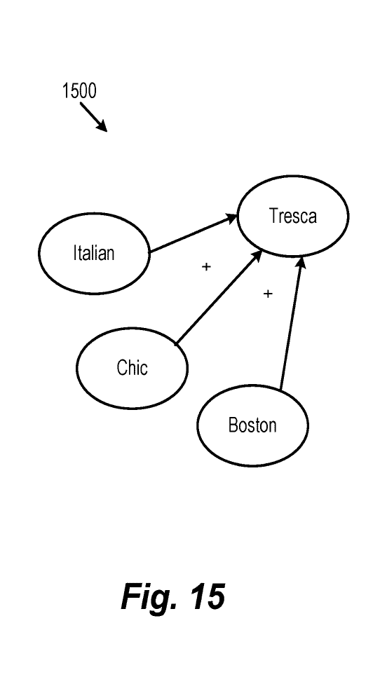

FIGS. 15-18 are exemplary diagrams of synaptic retrieval rules applied at step S808 of the synaptic network recommendation process 800, according to one example. The system 100 can apply one, several, or all of the synaptic retrieval rules when identifying the items to recommend to the user. FIG. 15 is an exemplary diagram 1500 of an excitation/summation synaptic retrieval rule, according to one example. According to the excitation/summation synaptic retrieval rule, convergent inputs to a node for which a user has an affinity can be summed to amplify the results via an “AND” operation, which increases the connection strengths for the converging input nodes to the at least one recommended item. For example, if the user likes a wine bar that is classified as “chic” and the user also likes waterfront views, then the system 100 may recommend a wine bar that is classified as “chic” and also is on a cliff with waterfront views.

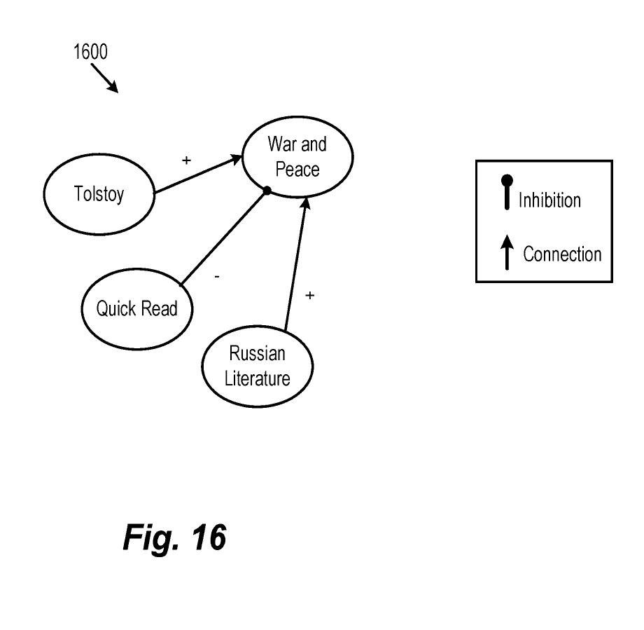

FIG. 16 is an exemplary diagram 1600 of a subtractive inhibition/cancellation synaptic retrieval rule, according to one example. According to the subtractive inhibition/cancellation synaptic retrieval rule, one or more competing or contradictory connections to a recommended item are suppressed, which sharpens a set of recommended results. Also, one or more nodal groupings can cross-suppress one another to further refine the recommended results. For example, diagram 1600 shows a user prefers the book “War and Peace.” Based on the subtractive inhibition/cancellation synaptic learning rule, a contradictory connection of “quick read” can be suppressed, which further amplifies the other attributes of “Tolstoy” and “Russian Literature” that describe the book. In addition, a restaurant that receives a five-star rating from a reviewer inhibits a restaurant that receives a one-star rating from the reviewer. Similarly, a restaurant that is “cheap” inhibits a restaurant that is “expensive.”

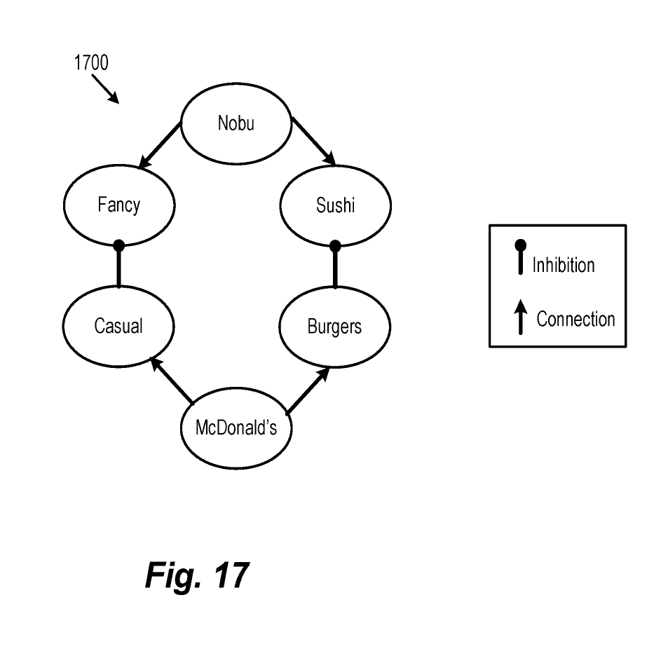

FIG. 17 is an exemplary diagram 1700 of a lateral inhibition/competition synaptic retrieval rule, according to one example. According the lateral inhibition/competition synaptic learning rule, nodal sub-networks of two or more connected nodes are generated that cross-suppress other nodal sub-networks based on a number of activations of nodes within the nodal sub-networks. The more active one sub-network is, the more able the nodal sub-network is to suppress a competing sub-network and thus prevent cross-suppression. As shown in the diagram 1700, a set of recommendations for a user may converge on two nodal sub-networks such as “fancy sushi” versus “casual burgers,” which compete to suppress one another based on the number of nodal activations within the nodal sub-network.

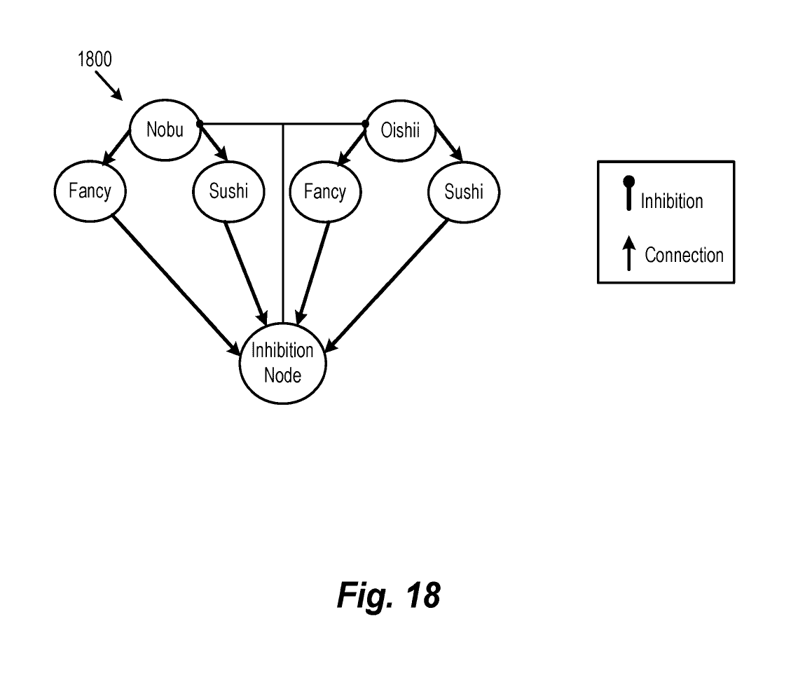

FIG. 18 is an exemplary diagram 1800 of a divisive inhibition/normalization synaptic retrieval rule, according to one example. According to the divisive inhibition/normalization synaptic retrieval rule, an inhibition node connected to one or more of the nodes of the synaptic network normalizes a number of nodal activations to within a predetermined range by responding dynamically to activation. For example, if a user “likes” 500 movies and thus activates a large number of nodes, saturation of the synaptic network will be reduced due to dynamic inhibition from the inhibition node, which normalizes the effect of the 500 movie “likes.” In addition, as shown in the diagram 1800, the inhibition node 1802 dynamically normalizes the “fancy sushi” restaurants “Nobu” and “Oishii” to within a predetermined range to reduce a likelihood of oversaturating the synaptic network with activations of the restaurants.

### Distributed Representation Recommendation Model

In some implementations, recommendations can be generated for users with the recommendation engine that uses a distributed representation model of items and reviews. In some implementations, the distributed representation model is a computerized neural network implementation that can outperform alternating least squares (ALS) matrix factorization algorithms without numbers of items and reviews that correspond to the number of users. In addition, the recommendation engine can implement a hybrid of the distributed representation model that incorporates a probabilistic network of items and their attributes, such as the synaptic network described previously herein. The generation of the probabilistic network can also be referred to as associative learning. The hybridization model augments the synaptic network described previously with the distributed representation model of the computerized neural network that allows explicit representations of attributes of items to be maintained, which enables recommendations to be made for items that have not received any reviews. This hybridization model can be implemented in situations where there are large amounts of reviews or in cold start conditions where many items have no reviews. Unlike traditional neural network implementations, the distributed representation model and the hybridization model may not suffer from reduced performance in the presence of sparse input vectors. In addition, the distributed representation model can be implemented in both recurrent and non-recurrent networks of data and can be scaled based on an amount of data included in the network. Instead of representing a user by a unique vector of latent features like in the ALS matrix factorization algorithms, each item and review can be combined to represent a particular user. In addition, the representation model can outperform a conventional matrix factorization algorithm, particularly in low-dimensional or low-feedback settings.

Throughout the disclosure, the terms ratings and reviews can be used interchangeably. In some implementations, references to ratings refer to a numerical rating for an item on a predetermined scale that indicates a user's affinity for that item. For example, the ratings can be on a five-star rating scale where the user can provide a review for the item by assigning it a rating from zero stars to five stars. Also, the rating scale described herein is zero stars to five stars rating scale, but other rating scales can also be used.

In some aspects, a recommender problem can be defined such that a matrix of ratings R= [symbol] ^{v×k} where v is the number of users and k is the number of items, and scalar R_{i,j} is a value of a review (rating) that user i gave item j, as shown by the following example:

$$R = [ \begin{matrix}0 & 2 & 3 & 0 & … \\ 0 & 0 & 0 & 1 & … \\ 0 & 4 & 0 & 0 & … \\ 5 & 0 & 1 & 0 & … \\ ⋮ & ⋮ & ⋮ & ⋮ & ⋱\end{matrix} ]$$

In some examples, the matrix R is sparse as any given user may be unlikely to have given reviews for a large number of items. A goal of the distributed representation model or the hybridization model is to be able to use observed ratings in order to assign values to all unobserved ratings in the matrix R. In one example, observed ratings are items that a user has explicitly rated, while unobserved ratings are items that have no feedback (i.e. the zero entries in R). An estimated ratings matrix \hat{R} can be obtained by assigning values to all of the entries of the matrix R that are zero. An entry \hat{R}_{i,j} represents what user i would have rated item j had the user observed it, as can be shown by the following example:

$$R = [ \begin{matrix}4 & 2 & 3 & 5 & … \\ 2 & 3 & 3 & 1 & … \\ 4 & 4 & 3 & 5 & … \\ 5 & 2 & 1 & 1 & … \\ ⋮ & ⋮ & ⋮ & ⋮ & ⋱\end{matrix} ]$$

In addition, a function that a recommendation algorithm seeks can be described as: ƒ: R→\hat{R}.

ALS algorithms attempt to find the function ƒ by factorizing the review matrix R to a user matrix Uε [symbol] ^{v×k} and an item matrix Mε [symbol] ^{k×d} where d is a hyper-parameter of the model denoting the number of latent features to use. Both the user and item matrices can be randomly initialized, and each row of the matrix U represents the d latent features of a user. Similarly, the row vectors in M represent latent features of the items. To solve a matrix factorization problem, the ALS algorithm treats the matrix U as a constant and optimizes a loss with respect to M. The ratings matrix R is used as an expectation in order to determine the loss (e.g., sum of squared errors). The matrix M is then used as a constant, and the loss function is sampled again in order to learn the matrix U, and the process is repeated.

Typically, the matrices U and M that are obtained without regularization overfit the data and do not allow for a generalizable function. This problem can be solved by adding a weighted regularization term to the cost function being optimized. One such cost function l mentioned can be defined for all single user-item pairs as:

$$l = {\sum }_{{∀}_{i , j} \vert {R}_{i , j} \neq 0} {( {R}_{i , j} - {u}_{i}^{T} \cdot {m}_{j} )}^{2} + λ ( {\sum }_{i} {n}_{{u}_{i}} {‖ {u}_{i} ‖}^{2} + {\sum }_{j} {n}_{{m}_{j}} {‖ {m}_{j} ‖}^{2} )$$

The addition of the regularization term can penalize solutions with large parameters U and M. For example, both uᵢ and mⱼ can represent the i^{th} and j^{th} row vectors of matrices U and M. The parameter λ is a weight that can be fixed empirically be performing validation. Here, nᵤε [symbol] ^{1×v} is a vector where the value of nᵤ_{ᵢ} is the number of items user i has rated. Similarly, nₘε [symbol] ^{1×k} is a vector where nₘ_{ⱼ} the value of is the number of users that have rated item j.

In some implementations, a neural network recommendation algorithm can define a neural network that has a vector x ε [symbol] ^{1×32} as an input, a scalar expectation yε{0,1}, and a hidden layer of size h. The neural network can use a sigmoid activation function

$$σ ( x ) = \frac{1}{1 + {e}^{- x}}$$

and a learning rate α, which is a hyper-parameter. The parameters can be initialized so that θ₀ε [symbol] ^{h×32}, θ₁ε [symbol] ^{1×h}, b₀ε [symbol] ^{1×h}, and scalar b₁. Then, the feed-forward process can be described by the following equations:

ƒ(x)=σ(x·θ₀^{T}+b₀)

g(ƒ)=ƒ(x·θ₁^{T}+b₁)

With g as an output of the network, a squared error loss function can be defined by l(g)=½(g−y)². Stochastic gradient descent can be used to solve for the parameters of the model by sampling the loss function l iteratively with either single training samples or mini-batches. The parameters are modified each time the loss function is sampled by taking a partial derivative of the loss l with respect to each parameter θ₀, θ₁, b₀, and b₁. An example of a weight change for θ₁ and, θ₀ can be described by:

$${θ}_{1} ← {θ}_{1} - α \frac{\partial l}{\partial {θ}_{1}}$$

$$\frac{\partial l}{\partial {θ}_{1}} = \frac{\partial l}{\partial g} \frac{\partial g}{\partial {θ}_{1}}$$

$${θ}_{0} ← {θ}_{0} - α \frac{\partial l}{\partial {θ}_{0}}$$

$$\frac{\partial l}{\partial {θ}_{0}} = \frac{\partial l}{\partial g} \frac{\partial g}{\partial f} \frac{\partial f}{\partial {θ}_{0}}$$

The computerized neural networks used in the distributed representation model can be trained with dropout which includes retaining only predetermined inputs to any layer of the neural network at random with a probability p. In a case of linear regression, a single observation model takes an input vector xε [symbol] ^{1×32}, parameters θε [symbol] ^{1×32}, a scalar bias b, and a scalar hypothesis y, where:

\hat{d}ε{0,1}^{1×32} where Pr(\hat{d}ᵢ=1)=0.5

y=(\hat{d}*x)·θ^{t}+b

In some implementations, the recommendation engine learns distributed representations, also referred to throughout the disclosure as embeddings, via back-propagation, as described by D. E. Rumelhart, G. E. Hinton, and R. J. Williams, “Learning representations by back-propagating errors,” Cognitive modeling, 5(3):1, 1988, the entire contents of which is incorporated herein by reference. Distributed representations allow neural networks to learn representations of the data represented by the networks. In one example, the neural networks used by the recommendation engine learn representations by forming a look-up matrix. A representation of the input data (e.g., words, items, etc.) is a vector that can be looked up in the matrix and fed forward into subsequent operations and can be learned in the same fashion as other parameters within the neural network.

In order to compare the performance of the ALS matrix factorization algorithm to the performance of the distributed recommendation model of the computerized neural network, an analogous ALS matrix factorization algorithm can be described with corresponding terminology and parameters to the neural networks used in the distributed representation model. For example, a user embedding matrix Lᵤₛₑᵣε [symbol] ^{v×d} can be defined that is analogous to U and a parameter matrix θ₀ε [symbol] ^{k×d} that is analogous to M. In order to score users in a look-up matrix, a hypothesis for all items for all users can be described by h(Lᵤₛₑᵣ·θ₀^{T}). In neural network terminology, both parameters Lᵤₛₑᵣ and θ₀ are learned at the same time with respect to a cost function l.

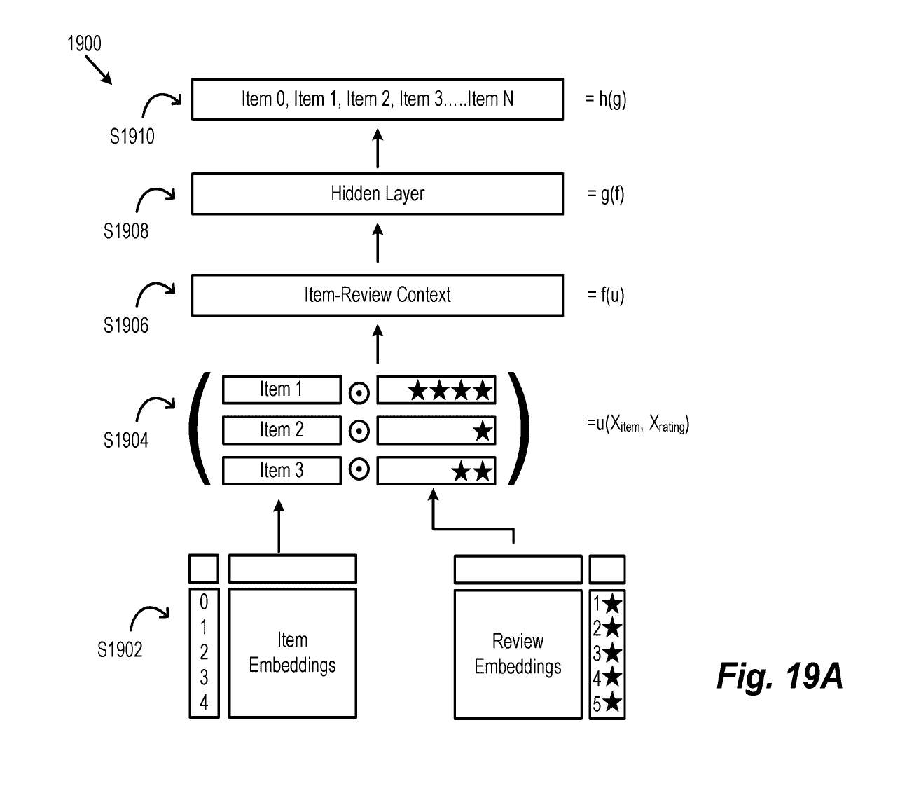

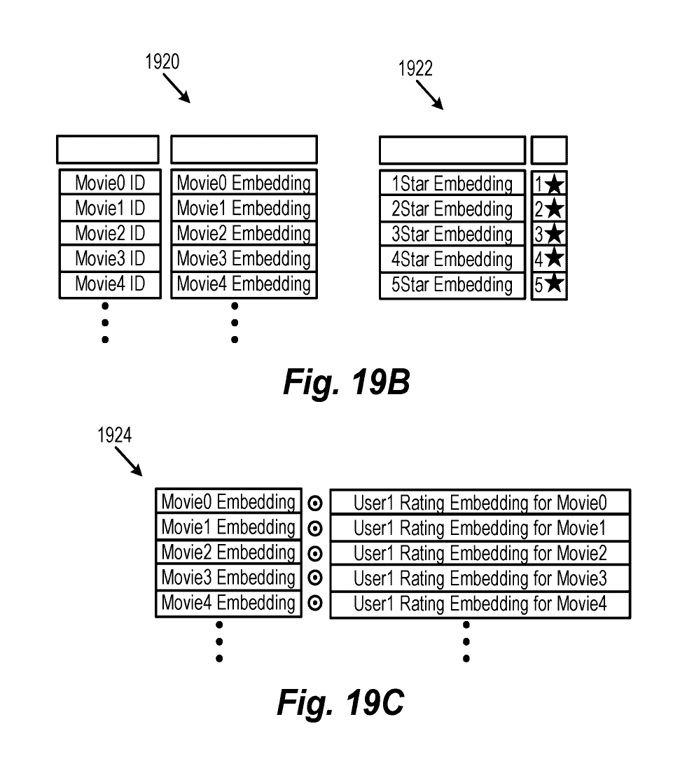

FIG. 19A is an exemplary flowchart of a distributed representation recommendation process 1900, according to one example, which can be performed by the recommendation engine 112 of the server 102. In some implementations, applying the distributed representation model to neural networks allows a network model to be constructed that may not include a large sparse vector that represents reviews for the user.

At step S1902, a neural network is constructed with embedding matrices Lᵢₜₑₘε [symbol] ^{k×d} and L_{review}ε [symbol] ^{s×d} where there are k number of items and s number of unique reviews with embedded dimensionality d. With a hidden layer size h, weight and bias parameters can be defined as follows:

θ₀ε [symbol] ^{h×d},b₀ε [symbol] ^{1×h}

θ₁ε [symbol] ^{k×h},b₁ε [symbol] ^{1×k}

In addition, n represents a total number of explicit ratings for a user in review matrix R, and an input to the network takes the following form:

(i₁,r₁),(i₂,r₂), . . . (iₙ,rₙ),

where iⱼ is the j^{th} element of a vector of items and rⱼ is the i^{th} element of a vector of reviews, which can also be referred to as ratings. The row vectors for all items and reviews can be looked up in their respective look-up matrices Lᵢₜₑₘ and L_{review} in order to form two matrices Xᵢₜₑₘ, X_{review} [symbol] ^{n×d}. Row vector Xᵢₜₑₘⱼ represents item iⱼ, and iⱼ is an index of the row in the look-up matrix Lᵢₜₑₘ, which means that row vector Xᵢₜₑₘⱼ→Lᵢₜₑₘⱼ. It is possible for X_{review} to have repeated row vectors, as users may often have given different items, such as movies, the same ratings.

For example, FIG. 19B includes diagrams of an exemplary item embedding matrix 1920 and an exemplary review embedding matrix 1922. The item embedding matrix 1920 includes unique identification codes (Movie0 ID, Movie1 ID, Movie2 ID, Movie3 ID, Movie4 ID, etc.) for all possible items that can receive reviews from a user. In one implementation, the items represented in the item embedding matrix 1920 may be movies that can be selected for streaming, purchasing, or rating by a user at a web or application interface. The item embedding matrix 1920 also includes a look-up matrix, which is a square matrix that includes a learned representation vector for each movies. The look-up matrix can be initialized to random values that are updated and optimized through the application of machine learning methods such as back-propagation, and the representation vectors for the movies converge to a set of values discovered by the system 100 that may represent explicit or hidden features. For example, Movie0 has a corresponding Movie0 embedding vector, Movie1 has a corresponding Movie1 embedding vector, and so on.

Likewise, the review embedding matrix 1922 includes unique identification codes (1-star, 2-star, 3-star, 4-star, 5-star, etc) for all possible ratings that a user can give to an item so that the ratings represent labels for vectors of a look-up matrix of the review embedding matrix 1922. The look-up matrix of the review embedding matrix is a square matrix that includes a learned representation vector for each of the possible item ratings. The look-up matrix of ratings can also be initialized to random values that are updated and optimized through the application of machine learning methods such as back-propagation, and the representation vectors for the movies converge to a set of values. For example, a 1-star rating has a 1star representation vector, a 2-star rating has a 2start representation vector, and so on.

Referring back to FIG. 19A, At step S1904, a forward pass of the neural network is performed, and dropout is applied, which randomly applies stress to the neural network to improve learning and overall performance. The matrices Xᵢₜₑₘ and X_{review} are multiplied together element-wise to determine an item-review context for a user. Then, dropout is applied so that approximately n/3 row vectors of the resulting matrix have zero values. In addition, the dropout vectors can be defined as follows:

\hat{d}₀ε{0,1}^{n×1} where Pr(\hat{d}₀_{ᵢ}=1)=0.33

\hat{d}₁ε{0,1}^{1×d}where Pr(\hat{d}₁_{ᵢ}=1)=0.5

\hat{d}₂ε{0,1}^{1×h}where Pr(\hat{d}₂_{ᵢ}=1)=0.5

The resulting item-review context matrix can be described by the following:

u(Xᵢₜₑₘ,X_{review})=(Xᵢₜₑₘ*X_{review})*\hat{d}₀

At step S1906, a column-wise average of the item-review context matrix is computed, which allows the neural network to accommodate variable length amounts of feedback (reviews) for each user. The column-wise average can be described as follows:

$$f ( u ) = \frac{{j}^{T} \cdot u}{n} where j ∈ {\{ 1 \}}^{n \times 1}$$

In some implementations, the vector ƒ can be a representation of a user.

The item-review context matrix ƒ (u) represents a profile for a particular user and is a unique vector that incorporates information related to the movies the user has watched and the ratings the user gave those movies. The item-review context matrix can indicate which movies the user prefers or does not prefer as well as how critical the user is of movies in general. FIG. 19C is an exemplary diagram 1924 illustrating how the item-review context matrix is generated for a user referred to as User1. The representation vector each movie reviewed by User 1 (Movie0, Movie1, Movie2, Movie3, Movie4, etc.) from the item embedding matrix 1920 is multiplied by a representation vector from the review embedding matrix 1922 that corresponds to the rating that User1 gave to a particular movie. For example, the representation vector for Movie0 is multiplied by the representation vector for the rating that User1 gave Movie0.

Referring back to FIG. 19A, at step S1908, the user representation ƒ is passed to a hidden layer, and ReLu is used as a non-linearity along with the dropout. In some implementations, ReLu is a function that computes relu(x)=max(0, x). The resulting vector g(ƒ) can be described by:

g(ƒ)=max(0,(ƒ*\hat{d}₁)·θ₀^{T}+b₀.

The hidden layer enables further recombination of relationships between an output layer of the neural network and the item-context review matrix layer with relationships learned through techniques such as back-propagation. Therefore, nodes of the hidden layer do not explicitly represent movies or other types of items but do represent dependencies between the item-context review matrix layer and the output layer computed at step S1910.

At step S1910, the output of the distributed representation model is computed and can be described by as h(g)=max(0, (g*\hat{d}₂)·θ₁^{T}+b₁. The output is a vector hε [symbol] _{>0}^{1×k} where an element hᵢ represents the rating or review that the user assigns item i. The expectation of the model can be defined by yε [symbol] ^{1×k} where yᵢ is a rating a user gave item i. In addition, the vector y provides a best performance when populated with all of the user's observed ratings. The loss l can be defined as the root mean square error (RMSE) in instances where there are explicit reviews from the user (only look at non-zero entries of y). The loss l can be described by the following:

$$l = \sqrt{\frac{1}{β} {\sum }_{{∀}_{i} \vert {y}_{i} \neq 0} {( {h}_{i} - {m}_{i} )}^{2}}$$

where β is a number of non-zero entries of y. The RMSE can be optimized with Adam, a variant of stochastic gradient descent that takes advantage of first and second moments of gradients as described in D. Kingma and J. Ba. Adam: “A method for stochastic optimization,” arXiv preprint arXiv: 1412.6980, 2014, the entire contents of which is incorporated herein by reference.

The output layer determined at step S1910 for the item-review context vector for User1 computed at step S1906 indicates movie recommendations for the User1. The output layer includes nodes for each possible movie to recommend that include a corresponding activation function h(g) that describe an amount of excitation for a movie based on the user profile. In other words, the activation function for each output node represents an amount of relevance of each recommendation to a user or an estimated rating for the movie by the User1.

The distributed representation recommendation process 1900 can be applied in online implementations because of an ability of the distribution model to shift a non-stationary distribution of ratings over items, which is a side effect of an assumption that the user who is interacting with the system 100 may only likely be exposed to a number of the recommendation engine's top choices. Because the user may be unlikely to rate items that he or she was not exposed to, an element of randomness can be introduced into the recommendations. For example, a temperature parameter with softmax normalization can be applied in order to induce diversity into the recommendation engine as described in R. S. Sutton and A. G. Barto, “Reinforcement learning: An introduction,” MIT press, 1998, the entire contents of which is incorporated herein by reference. The softmax function can be used to define probabilities which are used to draw items from a multinomial distribution. For example, for an output vector hε [symbol] _{>0}^{1×k}, the softmax normalization with a temperature tε [symbol] _{>0} can be described by

$$softmax ( h ) = \frac{{e}^{h / t}}{{Σ}_{i = o}^{k} {e}^{{h}_{i} / t}} .$$

As the temperature parameter t→inf, the probabilities across all items are approximately equal. In addition, the recommendation engine can draw from a multinomial distribution of \hat{n} trials, where each item is assigned a probability computed with the softmax function. A number of times each item was drawn during each of the \hat{n} trials is counted, and the items are sorted so that they occur in order of how many times the items are drawn from the multinomial distribution.

In large scale online implementations, the number of users can be far greater than the number of items that can be recommended, which corresponds to the distributed representation model that has a number of parameters that are not proportional to the number of users. For example, in a MovieLens 20M dataset that includes ratings of movies by users, a number of users corresponds to u=138,000 and a number of items corresponds to k=27,000. With a representation dimensionality of d=8, a matrix factorization model has a number of parameters that is equal to approximately k*d+s*d+d*h+h*k=1,080,304 with a hidden dimensionality h=32 and a number of unique ratings of s=6.

To evaluate the ability of the distributed representation model to generalize in the presence of different amounts of data when compared with the ALS matrix factorization algorithm, the RMSE of the distributed representation model can be compared to that of weight-regularized ALS on the MovieLens 20M dataset. Each model can be evaluated when given either two, five, or ten pieces of feedback (reviews) per user, and each model's performance can be evaluated based on a set of 10 pieces of feedback per user. In one example, a rank of the item and review matrices for the ALS algorithm is set to eight, and the dimensionality d of the embedding matrices for the distributed representation model is set to eight. For the ALS implementation, the regularization parameters are shown below in Table 2.

TABLE 2

| Amount of Feedback per User | λ |
|---|---|
| 2 | 0.5 |
| 5 | 0.4 |
| 10 | 0.3 |

The neural network used with the distributed representation can be initialized with a learning rate of 0.1 with the following schedule: lr←lr/5 every two iterations. In one example, the neural network is trained using a mini-batch size of 1024, and the ALS and distributed representation algorithms are run for 20 iterations of optimization. Table 3 shows RMSE for both the ALS and distributed representation models.

TABLE 3

| Amount of Feedback per User | ALS | Distributed Representation |
|---|---|---|
| 2 | 1.2281 | 1.0425 |
| 5 | 1.0441 | 0.9796 |
| 10 | 0.9573 | 0.9354 |

In addition, Table 4 shows that using dropout in the distributed representation model improves the overall performance by reducing the RMSE.

TABLE 4

| | RMSE |
|---|---|
| No Dropout | 0.977094330424 |
| Dropout | 0.93538048649 |

In some implementations, the recommendation engine can determine nearest neighbors of the item representations. Computing the nearest neighbors of the representations allows the items that have similar co-occurrence statistics to be identified. For example, a similarity matrix Aε [symbol] ^{k×k} can be computed where element A_{i,j} represents a Euclidean distance between row vectors Lᵢₜₑₘ_{ᵢ} and Lᵢₜₑₘ_{ᵢ}. Multiplying all of the item representations by row vector Lᵢₜₑₘ_{ₛ} (i.e. the vector that represents the highest rating), the nearest neighbors of an item can be determined. For example, to determine the five nearest neighbors to the movie North by Northwest, all of the item vectors can be conditioned by the review vector L_{review}_{ₛ}, which produces an output of the following five movies in order of relevance: Manchurian Candidate, Cool Hand Luke, Piano, Psycho, and Shawshank Redemption.

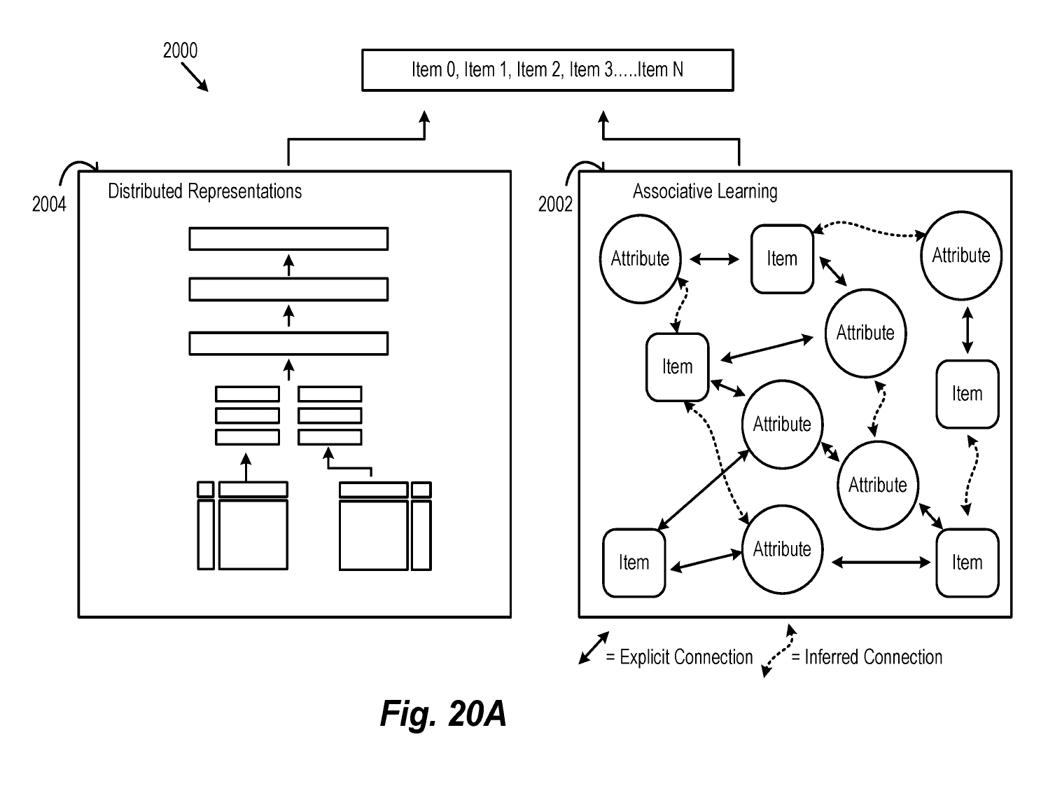

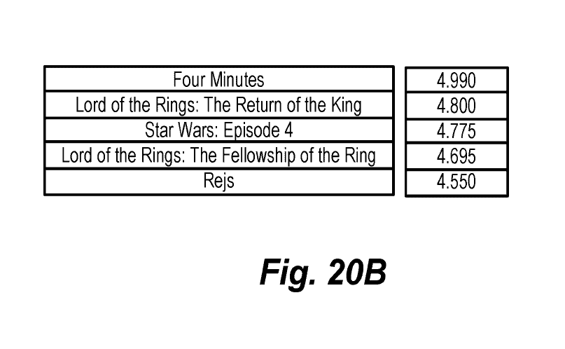

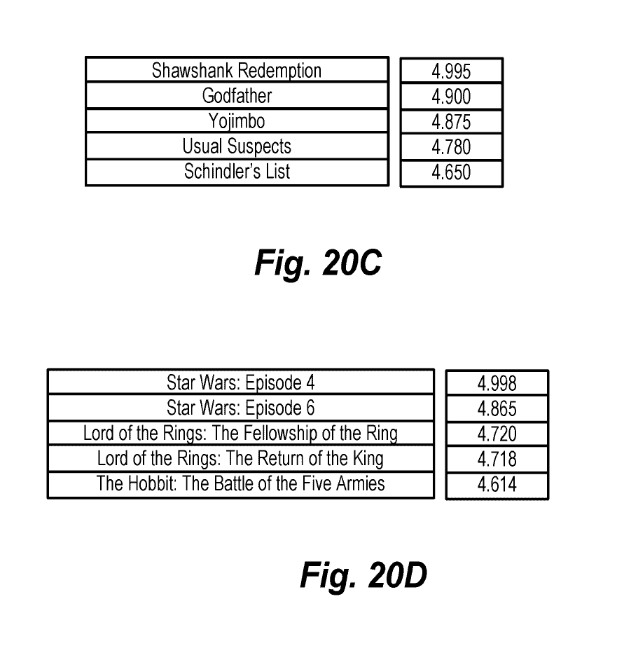

FIG. 20A is an exemplary diagram of a hybrid recommendation model 2000, according to one example. In some implementations, the hybrid recommendation model 2000 includes aspects of a distributed representation model 2004 as well as associative learning models 2002 and can be used to recommend items that have no feedback or reviews available. For example, the recommendation engine can determine that the hybrid recommendation model 2000 should be used when predetermined cold start criteria are met, such as when a number of ratings for a particular user is less than a predetermined threshold.

Both a traditional neural network and a matrix factorization model may have to add randomly initialized parameters in order to accommodate a new item that has no feedback. However, the recommendation engine can use the features of a new item with no ratings that is added to the network to predict how a user may rate the item. By using information about how frequently a user has interacted with features in the past, an associative learning model 2002 can be used to estimate a probability distribution for the user and item for all ratings. The associative learning model 2002 can include any type of probabilistic learning associated with neural networks, such as the synaptic learning rules described previously herein. In the associative learning model 2002, users, attributes, ratings (reviews), and items can be represented by nodes, and connection weights between the nodes can be assigned based on co-occurrence statistics of these nodes with each other. For item i, user u, and rating r: P(r=5|i, u) ∝P(r=5|u)P(i, u|r=5), where P(r=5|i, u) is a frequency that a user assigns an item a rating of 5. P(i, u|r=5) can be modeled with a vector zε [symbol] ^{1×q}, where q is a number of unique attributes for all items. In addition, each element zⱼ denotes how many times a user interacted with the j^{th} attribute out of the items that the user rated as a 5 in the past. A linear combination of the vector z can be computed, and the item vector eε{0,1}^{1×q} where the value eⱼ=1 denotes a presence of the j^{th} attribute, and a probability that a given item for a particular user is given a rating of 5 is determined.

In addition to defining explicit probabilities between nodes in the neural network, the recommendation engine can also infer probabilities between the nodes. In one example, two nodes node₁ and node₂ both share an attribute qᵢ, and qⱼ can be defined as an attribute that node₂ has that node₁ does not have. A connection can be formed between node₁ and qⱼ where a connection weight is a function of how many times the features qᵢ and qⱼ co-occur across historical reviews from many users. Once the recommendation engine builds the relationships between the users and items based on the associative learning model 2002, the recommendation engine can apply the distributed representation model 2004 by applying the distributed representation recommendation process 1900 described previously herein.

In examples where the hybrid recommendation model 2000 is implemented, the recommendation engine of the system 100 determines the recommended movies for the user based on a first set of recommended movies generated with the synaptic network recommendation process 800 and a second set of recommended movies generated with the distributed representation recommendation process 1900. For example, the output layer of the distributed representation recommendation process 1900 includes the first set of recommended movies for a particular user that includes a numeric score indicating an amount of relevance that movie has to the user, which may be a representation of the activation function value, h computed at step S1910. The output of the synaptic network recommendation process 800 includes the second set of movie recommendations that are independent from the first set of movie recommendations associated with the distributed representation model that also include a score for each movie indicating an amount of activation of each recommended movie node. The amount of activation represents an amount of affinity the user may have for the movie based on other movies the user has rated that have similar attributes.

In some implementations, the numeric scores associated with the first set of recommended movies and the second set of recommended movies reflect a predetermined rating scale where each score represents a number of stars in a five-start rating scale, but other rating scales can also be used. For example, a recommended movie from either the distributed representation recommendation process 1900 or the synaptic network recommendation process 800 may have a numeric score of 4.75, which indicates that the user may rate the movie between 4 and 5 stars based on learned connections or representations of the users' preferences for movies. The recommendation engine combines the scores from the first set and second set of recommended movies by a straight average or weighted average and determines the recommended movies based on the combined scores where the highest scores reflect the most highly recommended movies. In some implementations, the recommendation engine can determine the weights to apply to the weighted average of the scores based on predetermined criteria, such as how much training data has been applied to the system 100. For example, during cold starts where little or no training data is available, the second set of numeric scores output from the synaptic network recommendation process 800 may be assigned weighting factors that are greater than weighting factor for the first set numeric scores output from the distributed representation recommendation process 1900. As the amount of training data goes up, the weight factors for the first set of numeric scores associated with the distributed representation model 2004 may increase and the weighting factors for the second set of numeric scores associated with the associative learning (synaptic network) model 2002 may decrease. The recommendation engine can also determine the weighting factors by determining how selected weighting factors predict past performance and setting the weighting factors that result in outputs that most closely predict past performance.

FIGS. 20B-20D are exemplary diagrams of movie recommendation results and activation function values for a particular user based on the user giving the movies The Lord of the Rings: The Two Towers and Star Wars: Episode 5 a rating of 5 stars, according to one implementation. The numeric scores for each of the recommended movies represent an amount of relevance that the movie may have to the particular user or an projected rating for the movie by the user. For example, FIG. 20B is an exemplary diagram of recommendation results and exemplary activation function values based on an ALS recommendation algorithm when trained with ten pieces of feedback per user. FIG. 20C is an exemplary diagram of recommendation results and exemplary activation function values based on an the hybrid distributed representation model when trained with 10 pieces of feedback per user. FIG. 20D is an exemplary diagram of recommendation results and exemplary activation function values based on an the hybrid distributed representation model in a cold start scenario with no training. The numeric scores associated with the recommended movies in FIGS. 20C and 20D reflect combined scores from distributed representation model 2004 and the associative learning model 2002.

### User Interface

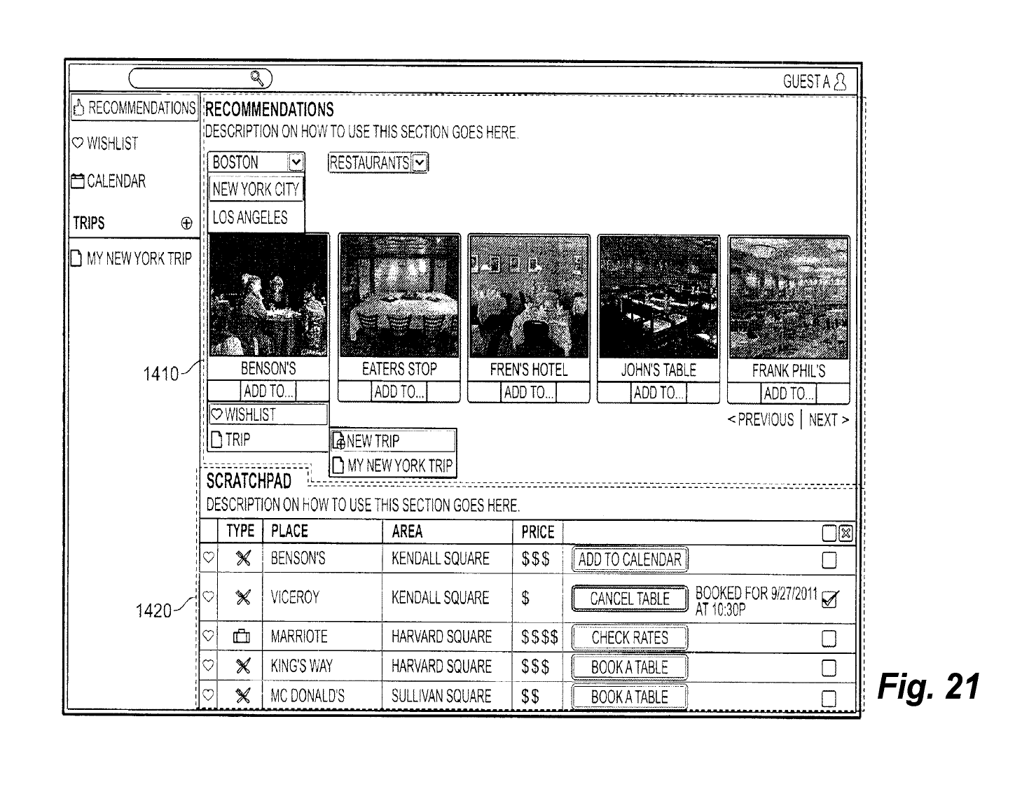

FIG. 21 is an exemplary user interface for deployment at a web portal or client device such as a desktop computer, smart phone, tablet PC, automotive multimedia interface or other mobile computing device. The server or local application provides an evolving personalized brand logo and personalized audio soundtrack to match the displayed itinerary. The sound track may persist and “travel” with the user as he or she navigates different functionalities or pages through the interface. The interface is also designed to provide bio-visual data feedback to the user. The system permits users to state their goals and intentions based on the feedback they have received from the system.

FIG. 21 is an overview page that provides users with an immediate perspective on options, a space for collection/comparison/pre-screening/deliberation, and the ability to immediately act. Specifically, the overview page has three distinct sections and functionalities.

First, at the recommendation panel 1410, a plurality of recommendations are presented. In preferred embodiments, there are five recommendations provided as shown in FIG. 21. In other embodiments, two to seven, three to six, four to six, four to eight, four to nine, or two to ten recommendations are provided. The number of recommendations may be on a per-venue basis so that five recommendations are provided for restaurants and a like number of hotels are recommended. Alternatively, a lesser number of complementary venue (e.g. hotel) recommendations are provided.

Second, the collection and comparison panel 1420 provides a place to compare and contrast recommendations of interest. The panel provides venue genre or type, the venue name, geographic area, and price. The panel also provides buttons to book a reservation or check availabilities or rates for the various venues. Buttons for adding the event to the Ava calendar (discussed below) are optionally provided adjacent each venue. Also provided are status identifiers indicating the current state of activities and/or bookings for each venue. Optionally, buttons may be provided to launch a window or image that depicts the venue on a map.

Third, the calendar panel (not shown) will feed or import a view of the user's personal Ava calendar and provide interactivity for immediate assessment of the user's schedule and available times. The calendar permits import of the user's other appointments and export of the Ava calendar items to any third party calendar systems such as Outlook, Google, and iCal.

These three panels are arranged down the page so that decision-making flows down the page from menu of options (top), to deliberation and comparison (middle), to arriving at a decision, and finally to scheduling/booking/publishing/sharing/taking action (bottom). This arrangement may in certain embodiments facilitate decision-making.

A user can directly book a recommendation at any of these three stages, or add to calendar at either of the first two stages. This arrangement may in certain embodiments enhance the likelihood that a user makes reservation or booking based on the recommendations.

Additional optional functionalities (not shown) include a transportation reservation interface. For example, the interface may present a transportation button that launches an booking or reservation portal which communicates with a third party transportation provider, such as a taxi service, and makes a reservation corresponding to a restaurant or other reservation. The interface may also permit the arrangement of transportation services between and amongst a plurality of other recommended events spanning one or more days.

In similar vein, booking functionality may be provided for a variety of complementary venues, services or activities. Examples include hotel rooms, airline reservations, movie tickets, theatre tickets, museum tickets, music tickets, sporting events, product delivery (such as flowers or flowers), real estate services, or moving services (such as inter-city packing and transportation services).

The interface may selectively suggest alternative actions or venues based on a first booked venue or action. For instance, the booking of a restaurant reservation may prompt the generation of night club or theater recommendations. As another example, the booking of a real estate tour through a real estate agency may prompt a recommendation for moving services. Subsequent bookings may in turn generate additional recommendations complementary to the most recent booking, the earlier booking, or both.

These follow-on recommendations may be filtered and selected according to the techniques set forth above. In particular, the recommendations may be function of the user's profile, attributes, venue preferences, past booking behavior and/or previous feedback concerning certain venues. For instance, the recommendations may be filtered as set forth above according to the user's most recent reservations and the user's expressed preferences for given venues that are linked to potential secondary or tertiary recommendations.

Recommendations may also be provided based on real-time location information, such as that provided by smart-phone GPS data. The system 100 may send an electronic message or alert either including a recommendation based in part on the location and/or time or prompting the user to access an interface to receive the recommendation. For instance, if a user is known to be proximate to a theater shortly before a show which the recommendation engine ranks highly for that particular user the system 100 may generate an electronic alert to the user including the recommendation, a hyperlink to the system web portal, or a link to active a client recommendation application which can launch the interface described herein.

Alerts or recommendations may be accompanied by, and be generated based on, promotional offers related to the venues, For instance, an electronic notification may contain a recommendation along with a promotional discount offer for the related potential booking or reservation. Recommendations presented in the interface (or via electronic messages) may also be selected based in part on promotional status. That is to say, the recommendation engine may strengthen links nodes associated with promotional offers and thus the engine will factor in promotional offers when determining nodes to recommend (i.e. those most strongly linked to nodes associated with the user or a recommendation request).

Users' feedback concerning recommended venues and the associated “take rates” may likewise be factored in by the recommendation engine. For example, the link strengths may be increased for venues for which users more frequently make reservations based on the recommendations, consistent with the techniques taught herein.

Users may be provided a profile page or “my account” page that provides analytics on that data and any other data collected or contributed to provide perspective and insight into behavior. The page provides a feedback mechanism to the user that is “habit honing” in that analytics on self-activity are provided in a visual format. For example, the page may present graphical trends of actions within customizable goal categories such as health (gym, yoga), family (museums, travel, dining), and errands (dentist, mechanic, groceries 1. Based on user defined goals, the overview page suggestions can be featured to highlight relevant activities to fill existing calendar time-slots.

The interface may also provide other prompts to facilitate action and hone habits. For example, the interface may provide cues and triggers embedded in mobile device applications to cue initiation of plans and transitions between scheduled events. For instance, the mobile client application may trigger chimes upon next scheduled event, music to reduce anxiety surrounding errands, tailored music transitions upon the occurrence of the next scheduled event, or visual (blinking LED) cues upon next scheduled events.

The interfaces described herein may be presented, as noted, through a variety of devices. Still additional devices are contemplated, including television screens, third party websites (through partnerships), in-store kiosks, or personal keychains or dongles.

The venues are operated by third parties, which may include merchants such as restaurant owners, airlines, or hotel operators. In addition, merchants may also control the sale of other types of items, such as clothing, movies, music, and the like. The system 100 may be configured to provide merchants a visualization of users' behavior. For instance, merchants may be provided access to ant trail data patterns, including in real time. Merchants can “interact” with these patterns and request the system 100 to inject disruptive content such as promotional offers related to a user's present location and expressed preferences.

Merchants may also be provided anonymized profiles of the likes and dislikes of their customers (i.e. users who patronize their establishment). This can include reviews provided by reviewers and users who provide feedback (who also constitute reviewers).

The user interface may include i) a set of HTML files that define the look and feel of the web interface, with design elements styled using cascading style sheets (CSS), ii) a server-side set of scripts that dynamically generate those HTML files using a backend scripting language (PHP, etc) running on a web server (Apache, etc.), iii) a client-side set of scripts and interface libraries that allows rich user interaction within the browser (Javascript, jQuery, etc.), and iv) a backend database that provides the data to the web application (Amazon SimpleDB, etc.).

The functionality of the user interface includes permitting the user to create an account and log in using secure credentials that are verified against an encrypted user table in our backend database. The interface also allows a user to browse objects and see whether they are recommended or not. The interface allows a user to filter those objects by city, by category, and then by a host of properties pertinent to those categories. The user can enter feedback on their recommendations by clicking on thumbs up/thumbs down or other feedback mechanisms. The interface allows a user to drag and drop recommendations onto a “being considered” area where they can be compared across different parameters using sortable headers, etc. The interface allows a user to drag an object onto their calendar in order to “action” it by going to the object at a certain time. The interface allows a user to build events, such as “My New York City Trip” where the user can create a group of restaurants, hotels, and other opportunities that have been recommended. The user can enter notes about their recommendations to remind themselves of various impressions, for example. The user can print out a copy of itineraries for their events, or email those itineraries to themselves. Their calendar is also synchronized with the global calendar on their smart phones, etc. The user can share their recommendations with others, or build events and share those with others.

The interface may be delivered via a scalable cloud architecture. Web servers run as Linux CPU nodes on Amazon's elastic cloud computing (EC2) system. Web servers receive independent IP addresses using Elastic IP or other IP address mediators. Web servers are monitored for load, and users are dynamically distributed among the servers. Excessive user load trips a threshold which leads to the creation of more EC2 nodes. When user load drops too low, that trips a threshold which leads to the delete of EC2 nodes to save cost.

A list of all recommended objects is pre-computed for the user. When the user requests objects via the interface, the system simply checks to IDs of those objects prior to presentation to see whether the objects appear on the recommended list or not. In another iteration, the personalization is computed in real time with no pre-cached list of recommended objects. In this example, as objects were going to be presented through the interface, they are run through the personalization engine at that moment to compute if they are recommended or not.

### Hardware Implementation

In some examples, the server and/or client device (e.g. desktop computer or smart phone) are implemented in digital electronic circuitry, or in computer hardware, firmware, software, or in combinations of them. The apparatus is optionally implemented in a computer program product tangibly embodied in an information carrier, e.g., in a machine-readable storage device or in a propagated signal, for execution by a programmable processor; and method steps are performed by a programmable processor executing a program of instructions to perform functions of the described implementations by operating on input data and generating output. The described features are optionally implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that are optionally used, directly or indirectly, in a computer to perform a certain activity or bring about a certain result. A computer program is optionally written in any form of programming language, including compiled or interpreted languages, and it is deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory are optionally supplemented by, or incorporated in, ASICs (application-specific integrated circuits).

To provide for Interaction with a user, the features in some instances are implemented on a computer having a display device such as an LCD (liquid crystal display) monitor or screen for displaying information to the user and, in the case of a desktop computer, a keyboard and a pointing device such as a mouse or a trackball by which the user provides input to the computer.

In various implementations, the client device is a smart phone such as that described in U.S. Pat. No. 7,966,578, entitled “Portable Multifunction Device, Method, and Graphical User Interface for Translating Displayed Content,” assigned to Apple, Inc., which is incorporated herein by reference.

The server functionality described above is optionally implemented in a computer system that includes a back-end component, such as a data server, or that includes a middleware component, such as an application server or an Internet server, or that includes a front-end component, such as a client computer having a graphical user interface or an Internet browser, or any combination of them. The components of the system are connected by any form or medium of digital data communication such as a communication network. Examples of communication networks include, e.g., a LAN, a WAN, and the computers and networks forming the Internet.

The computer system optionally includes clients and servers. A client and server are generally remote from each other and typically interact through a network, such as the described one. The relationship of client and server arises by virtue of computer programs running on the respective computers and having a client-server relationship to each other.

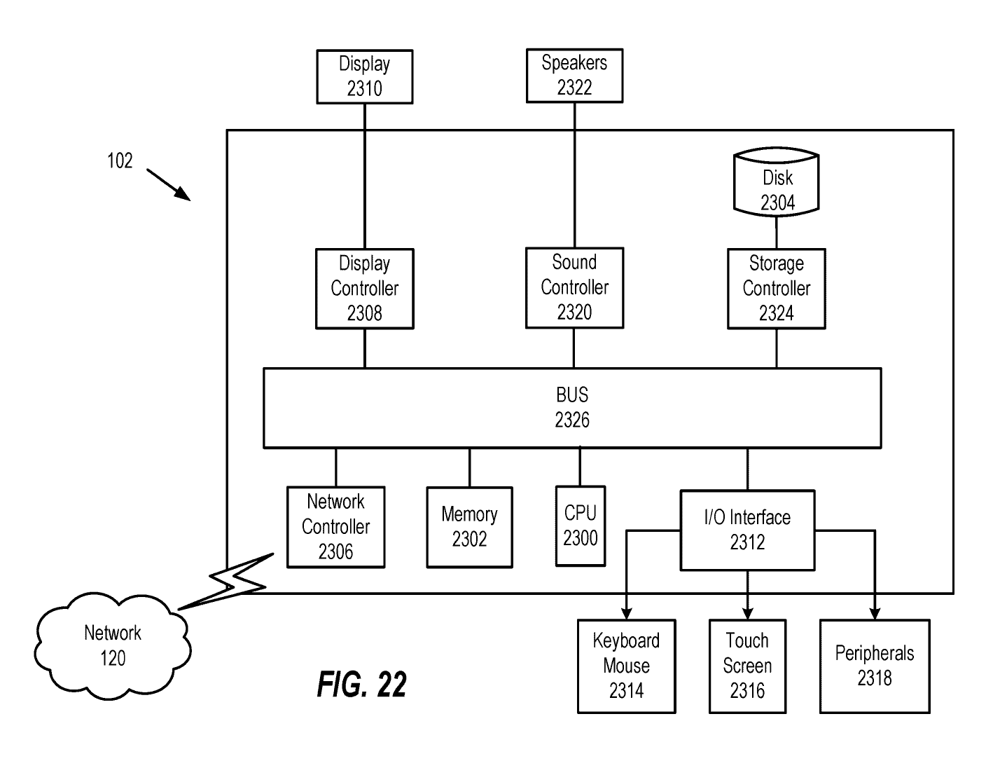

Next, a hardware description of the server 102 according to exemplary embodiments is described with reference to FIG. 22. In FIG. 22, the server 102 includes a CPU 2300 which performs the processes described above/below. The process data and instructions may be stored in memory 2302. These processes and instructions may also be stored on a storage medium disk 2304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the server 102 communicates, such as another server or a computer.

Further, the claimed advancements may be provided as a utility application, background daemon, or component of an operating system, or combination thereof, executing in conjunction with CPU 2300 and an operating system such as Microsoft Windows 7, UNIX, Solaris, LINUX, Apple MAC-OS and other systems known to those skilled in the art.

The hardware elements in order to achieve the server 102 may be realized by various circuitry elements, known to those skilled in the art. For example, CPU 2300 may be a Xenon or Core processor from Intel of America or an Opteron processor from AMD of America, or may be other processor types that would be recognized by one of ordinary skill in the art. Alternatively, the CPU 2300 may be implemented on an FPGA, ASIC, PLD or using discrete logic circuits, as one of ordinary skill in the art would recognize. Further, CPU 2300 may be implemented as multiple processors cooperatively working in parallel to perform the instructions of the inventive processes described above.

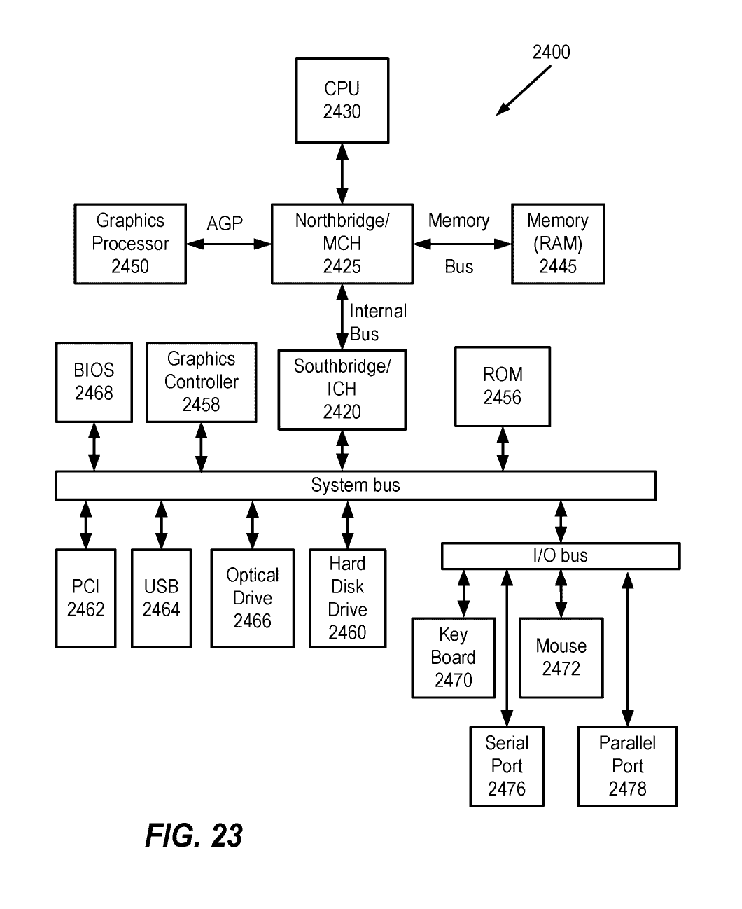

The server 102 in FIG. 23 also includes a network controller 2306, such as an Intel Ethernet PRO network interface card from Intel Corporation of America, for interfacing with network 120. As can be appreciated, the network 120 can be a public network, such as the Internet, or a private network such as an LAN or WAN network, or any combination thereof and can also include PSTN or ISDN sub-networks. The network 120 can also be wired, such as an Ethernet network, or can be wireless such as a cellular network including EDGE, 3G and 4G wireless cellular systems. The wireless network can also be WiFi, Bluetooth, or any other wireless form of communication that is known.

The server 102 further includes a display controller 2308, such as a NVIDIA GeForce GTX or Quadro graphics adaptor from NVIDIA Corporation of America for interfacing with display 2310, such as a Hewlett Packard HPL2445w LCD monitor. A general purpose I/O interface 2312 interfaces with a keyboard and/or mouse 1514 as well as a touch screen panel 2316 on or separate from display 2310. General purpose I/O interface also connects to a variety of peripherals 2318 including printers and scanners, such as an OfficeJet or DeskJet from Hewlett Packard.

A sound controller 2320 is also provided in the server 102, such as Sound Blaster X-Fi Titanium from Creative, to interface with speakers/microphone 2322 thereby providing sounds and/or music.

The general purpose storage controller 2324 connects the storage medium disk 2304 with communication bus 2326, which may be an ISA, EISA, VESA, PCI, or similar, for interconnecting all of the components of the server 102. A description of the general features and functionality of the display 2310, keyboard and/or mouse 2314, as well as the display controller 2308, storage controller 2324, network controller 2306, sound controller 2320, and general purpose I/O interface 2312 is omitted herein for brevity as these features are known.

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 23.

FIG. 23 shows a schematic diagram of a data processing system, according to certain embodiments, for performing the functionality described herein. The data processing system is an example of a computer in which code or instructions implementing the processes of the illustrative embodiments may be located.

In FIG. 23, data processing system 2400 employs a hub architecture including a north bridge and memory controller hub (NB/MCH) 2425 and a south bridge and input/output (I/O) controller hub (SB/ICH) 2420. The central processing unit (CPU) 2430 is connected to NB/MCH 2425. The NB/MCH 2425 also connects to the memory 2445 via a memory bus, and connects to the graphics processor 2450 via an accelerated graphics port (AGP). The NB/MCH 2425 also connects to the SB/ICH 2420 via an internal bus (e.g., a unified media interface or a direct media interface). The CPU Processing unit 2430 may contain one or more processors and even may be implemented using one or more heterogeneous processor systems.

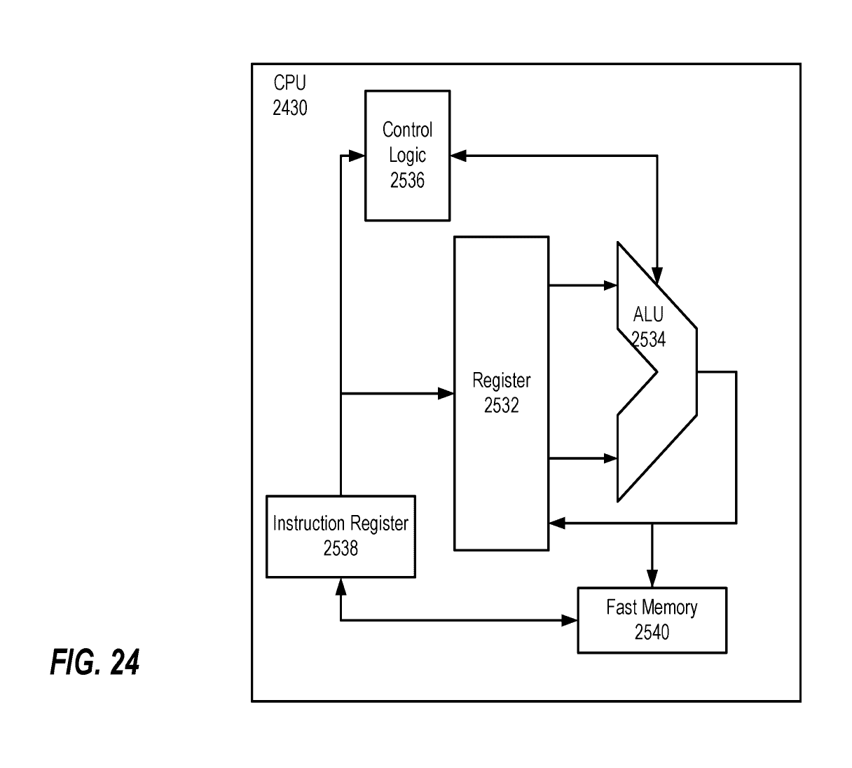

For example, FIG. 24 shows one implementation of CPU 2430. In one implementation, the instruction register 2538 retrieves instructions from the fast memory 2540. At least part of these instructions are fetched from the instruction register 2538 by the control logic 2536 and interpreted according to the instruction set architecture of the CPU 2430. Part of the instructions can also be directed to the register 2532. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 2534 that loads values from the register 2532 and performs logical and mathematical operations on the loaded values according to the instructions. The results from these operations can be feedback into the register and/or stored in the fast memory 2540. According to certain implementations, the instruction set architecture of the CPU 2430 can use a reduced instruction set architecture, a complex instruction set architecture, a vector processor architecture, a very large instruction word architecture. Furthermore, the CPU 2430 can be based on the Von Neuman model or the Harvard model. The CPU 2430 can be a digital signal processor, an FPGA, an ASIC, a PLA, a PLD, or a CPLD. Further, the CPU 2430 can be an x86 processor by Intel or by AMID; an ARM processor, a Power architecture processor by, e.g., IBM; a SPARC architecture processor by Sun Microsystems or by Oracle; or other known CPU architecture.

Referring again to FIG. 23, the data processing system 2400 can include that the SB/ICH 2420 is coupled through a system bus to an I/O Bus, a read only memory (ROM) 2456, universal serial bus (USB) port 2464, a flash binary input/output system (BIOS) 2468, and a graphics controller 2458. PCI/PCIe devices can also be coupled to SB/ICH 2420 through a PCI bus 2462.

The PCI devices may include, for example, Ethernet adapters, add-in cards, and PC cards for notebook computers. The Hard disk drive 2460 and CD-ROM 2466 can use, for example, an integrated drive electronics (IDE) or serial advanced technology attachment (SATA) interface. In one implementation the I/O bus can include a super I/O (SIO) device.

Further, the hard disk drive (HDD) 2460 and optical drive 2466 can also be coupled to the SB/ICH 2420 through a system bus. In one implementation, a keyboard 2470, a mouse 2472, a parallel port 2478, and a serial port 2476 can be connected to the system bust through the I/O bus. Other peripherals and devices that can be connected to the SB/ICH 2420 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The above-described hardware description is a non-limiting example of corresponding structure for performing the functionality described herein.

Aspects of the present disclosure are directed to generating recommendations for users based on learned relationships between nodes of a synaptic network where the nodes represent users, items, and attributes that describe the users and items. Advancement in processing and computing technologies provides the ability to construct and manipulate complex data networks according to the implementations described herein. The synaptic learning rules described herein can be codified into an engineering framework that can be applied to computing systems in order to provide more accurate representations of relationships between items, attributes, and users. The implementations described herein improve the functionality of computerized neural networks and can be applied across a wide range of technologies that use neural networks to determine patterns and trends in data. For example, aspects of the implementations described herein can also be applied to fraud detection, pattern recognition algorithms, physical system modeling, biometric signal processing, student performance predictors, energy demand predictors, etc. In addition, the distributed representation model and hybrid model described herein improve the functionality of traditional neural networks by combining features of distributed representation neural networks and synaptic networks.

Accordingly, the advancements described herein provide for the creation of improved data networks that enhance the way data is stored and retrieved, thereby providing faster processing of data which enables faster and more accurate searching when presenting recommendations than is possible with traditional network infrastructures. Therefore, the advancements described herein improve existing technological processes in a variety of technical arenas such as data storage, network architecture, forming data relationships and recommendation processing. Therefore, the systems and methods described herein are directed to a novel implementation implemented via special purpose computing rather than mere generic features implemented on a general-purpose computer.

A number of embodiments have been described. Nevertheless, it will be understood that various modifications are optionally made without departing from the spirit and scope of this disclosure. Accordingly, other embodiments are within the scope of the following claims.

What is claimed is:

1. A method comprising:
receiving attribute data for a plurality of users, the data relating to a plurality of attributes of a user and to at least a first venue for which the user has an affinity;
receiving venue data for a plurality of venues, the venue data relating to a plurality of attributes of the venues;
receiving review data for the plurality of venues, the review data reflecting the affinity of a plurality of reviewers for the plurality of venues;
accessing a data network comprising nodes corresponding at least to the plurality of venues and the plurality of reviewers and further comprising links between said nodes, each link reflecting a strength of an interrelationship between at least two nodes, wherein at least a plurality of the link strengths are a function of at least the review data and the venue data and wherein at least a plurality of the link strengths are further a function of both content-based and collaborative interrelationships;
determining, based on the link strengths and at least one venue parameter, a plurality of recommended venues having the strongest links to a user;
generating recommendation data comprising at least one recommended venue; and serving to a client device the recommendation data for display on a screen of the client device.
